(19) United States
(12) Patent Application Publication
(10) Pub. No.: US 2005/0065813 A1
(43) Pub. Date: Mar. 24, 2005

(54) Online medical evaluation system

(76) Inventors: David J. Mishelevich, Playa del Rey, CA (US); M. Bret Schneider, Thousand Oaks, CA (US); Steven W. Ainbinder, Henderson, NV (US); Alekasandar Sepetkovski, Belgrade (YU)

Correspondence Address: David B. Cochran;Jones Day, North Point, 901 Lakeside Avenue, Cleveland, OH, 44114, US

(21) Appl. No.: 10/384,817

(22) Filed: Mar. 11, 2003

(51) Int. Cl. G06F 17/60

(52) U.S. Cl. 705/2

(57) ABSTRACT

An online medical evaluation and treatment system includes a patient interface, a physician interface and diagnostic tools to gather and sort information sent from the patient and automatically generate candidate diagnoses. A patient enters information about a medical condition through the patient interface. The diagnostic tools evaluate the information provided by the patient, generate further questions, and create a list of possible diagnoses known as a differential diagnosis. A physician enters the physician interface to review a patient file and diagnose the medical condition of the patient. Importantly, the physician does not have to be present as the data is gathered from the patient, thus saving the physician time. The information gathered from the patient may also be exported to external databases for processing by a third party.

### CROSS-REFERENCE TO RELATED APPLICATIONS

This application claims the benefit of U.S. Provisional Application No. 60/362,764, filed Mar. 8, 2002, which is hereby incorporated by reference.

### TECHNICAL FIELD

The present invention is directed to the field of medical software systems, methods and electronic portals. More specifically, the invention provides a comprehensive system for enabling evaluation and treatment of patients by certified medical personnel via a data network, such as the Internet.

### BACKGROUND

Medical software system web sites are known in this field. These systems, however, suffer from many disadvantages that have limited their utility from the perspective of a patient, a physician (or other qualified caregiver) and also a healthcare management organization.

Example medical software systems use input from a doctor (or other medical personnel) to create a database entry that contains patient specific data. These medical software systems typically employ “smart agents” to suggest questions (or follow-up questions) based on answers to previous questions. Many of these “smart agents” are simply logic trees that branch to other questions based on the answer to a particular question. Once the system has traversed the logic tree, it then returns a diagnosis that is generally used as a check against the diagnosis the physician has independently determined. Within these systems, any single question that is misunderstood will illicit an incorrect response and cause the system to diverge from the correct diagnosis.

Another known type of medical software system eases the process of inputting data into a centrally stored, universal database. The creation of a universal database for storing patient data from numerous treating physicians located at different medical facilities is a goal of the healthcare industry. Such a database would help physicians diagnose symptoms that are prevalent in a patient's medical history. The database structure also minimizes the physical space required for records storage since hard copy (paper) records can be saved digitally. These types of universal database systems are implemented either by directly scanning the paper records of patient folders into the database or by incorporating a digital assistant into patient visits by the physician or other medical personnel. The digital assistant could be, for example, a PDA, laptop computer, handheld computer, or digital voice recorder.

The digital assistants used with this type of system are easily configurable to accept input from a physician during an patient visit. Within this system, however, the doctor is still required to input the necessary patient information gathered during the visit. This makes the physicians job more difficult because he first must gather the information and then record it in a structured format. Thus, the physician must spend a longer period of time with each patient or use an assistant to record the data. Both of these solutions result in added cost to healthcare management organizations and ultimately the patient.

Another type of known medical software system connects patients to a physician's office or hospital through a network connection. The network connection can be a data network, such as the Internet, or a phone network where a patient places a telephone call to a central location. These systems are designed to access patients who are remotely located from medical care, but who have non-serious medical conditions. By using this type of telemedical service, the remote patient can receive a medical diagnosis from a medical professional that the patient otherwise could not access. Interaction between the medical personnel and the patient in these telemedical systems is typically accomplished through e-mail, instant chat, videoconferencing or Internet phone.

There can occur incidences of epidemics or of biological, chemical or nuclear accidents or attacks. Such incidences can give rise to a prevalence of one or more particular ailments. In such cases, many people might suddenly notice the occurrence of abnormal symptoms, which would raise concern that they have contracted the ailments. This can lead to a large number of people seeking a medical diagnosis at one time. The number of people seeking the diagnosis might be more than medical personnel can handle.

### SUMMARY

An online medical evaluation and treatment system includes a patient interface, a physician interface and diagnostic tools to gather information from the patient and to generate diagnoses for review by a treating physician. Using this system, the patient enters information about a medical condition through the patient interface. The diagnostic tools evaluate the information provided by the patient, generate further questions based on the answers to previous questions, and create a list of possible diagnoses, referred to as a differential diagnosis. A treating physician then enters the physician interface, after the patient has entered the pertinent medical information, to review a summary report within a patient file and then to diagnose the medical condition of the patient. Importantly, the physician does not have to be present as the data is gathered from the patient, freeing the physician from gathering and/or inputting information into the system, and, thus providing a more time-efficient system for delivering medical treatments.

The diagnostic tools first gather, sort and order the information from the patient. Then, the diagnostic tools search a knowledge base for medical conditions that reach a predetermined level of overlap of the known symptoms for the medical condition as reported in the database and the reported symptoms gathered from the patient. Once the list of medical conditions meeting this criteria is gathered, then any symptoms that are present in the medical conditions, but have not been addressed through questions to the patient, are gathered, presented to the patient, and then the patient's answers are recorded so that the diagnostic tools can determine a set of candidate diagnoses.

According to one aspect of the present invention, an online medical system comprises a patient interface, a physician interface and server applications. The patient interface is configured to display and record medical information of a patient. The physician interface is configured to display a summary of the medical information recorded from the patient interface. The server applications are configured to query the patient interface and evaluate the answers to the queries such that the summary includes a differential diagnosis. The data gathered during this process can then be sorted and stored in a resident program or exported to a third party medical record.

According to another aspect of the present invention, an online medical evaluation system comprises a patient interface, a physician interface, and a data drilling module. The data drilling module is configured to generate queries which are sent to the patient interface, and then summarize results of the queries in the physician interface. The queries include graphical medical data.

According to another aspect of the present invention, a method of treating a patient includes the steps of: (1) querying a patient interface for general health symptoms; (2) determining if any general health symptoms answered during the query are abnormal. (3) building a differential diagnosis based on the abnormal symptoms of the general health query; (4) displaying the differential diagnosis to a physician using a physician interface; (5) the physician determining a diagnosis and (6) receiving the diagnosis from the physician. A list of treatments is then displayed in response to the diagnosis. The physician determines a treatment which is then displayed to the patient via the patient interface.

It should be noted that these are just some of the many aspects of the present invention. Other aspects not specified will become apparent upon reading the detained description of the drawings set forth below.

In another embodiment, a server is configured to interact with a patient through a browser interface from a remote location to query the patient for symptoms and risk factors. From the patient's responses, the server calculates a likelihood that the patient has a particular ailment. Operating parameters used by the server in the querying and calculating steps are set by a designated authority through a browser interface from another remote location.

### BRIEF DESCRIPTION OF THE DRAWINGS

FIG. 1 is a system diagram of an online medical evaluation and treatment system according to a preferred embodiment of the present invention;

FIG. 2 is a detailed diagram of certain software modules shown in FIG. 1;

FIG. 3 is a logical flow chart setting forth the preferred steps enabled by the patient interface of the present invention;

FIG. 4 is a logical flow chart setting forth the preferred steps enabled by the physician interface of the present invention;

FIG. 5 is a detailed diagram of the evaluation engine of FIG. 1;

FIG. 6 is a detailed diagram of the reference database of FIG. 1;

FIG. 7 is a logical flow chart setting forth the preferred steps enabled by the server applications of the present invention;

FIG. 8 is a graphical depiction showing an example layout of a differential diagnosis display generated by the server applications and viewed through the physician interface;

FIG. 9 is a graphical depiction showing an example layout of a possible treatments display generated by the server applications and viewed through the physician interface;

FIG. 10 is a graphical depiction showing an example of a physician report sent to a patient after a diagnosis and treatment regimen have been determined;

FIG. 11 is schematic diagram of another system embodying the present invention, for use by a patient and a designated authority;

FIG. 12 is a flow diagram for a process the system uses to interview the patient;

FIGS. 13, 14, 15A and 15B are web pages produced during the process of FIG. 12;

FIG. 16 is a flow diagram for a process the system uses to interview the designated authority; and

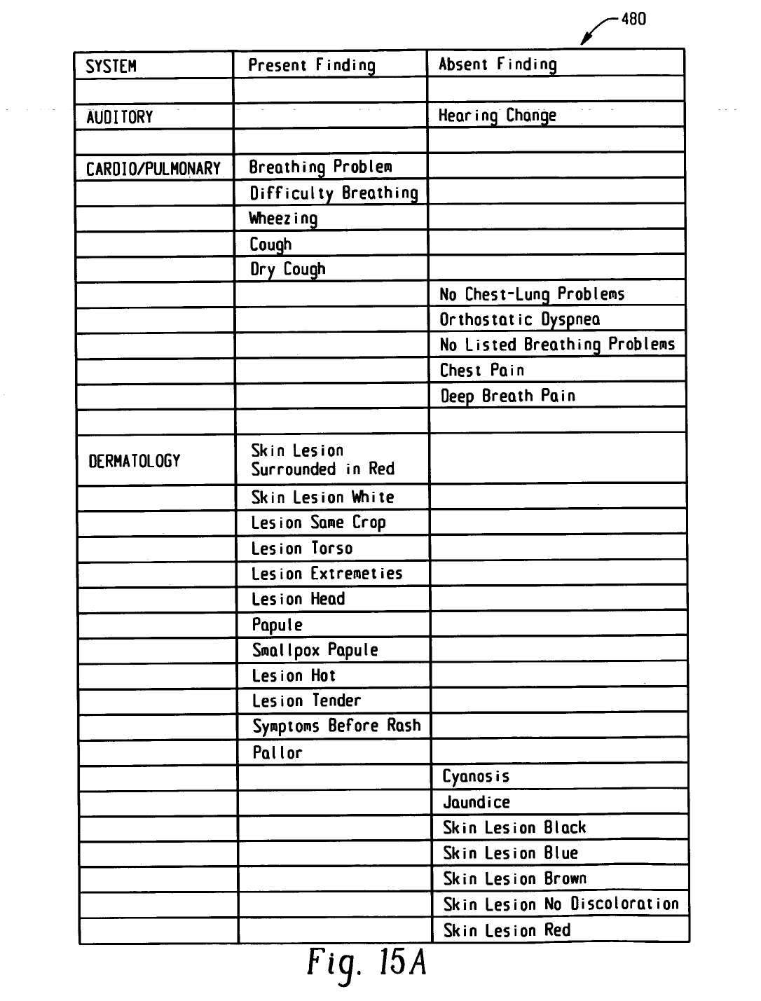

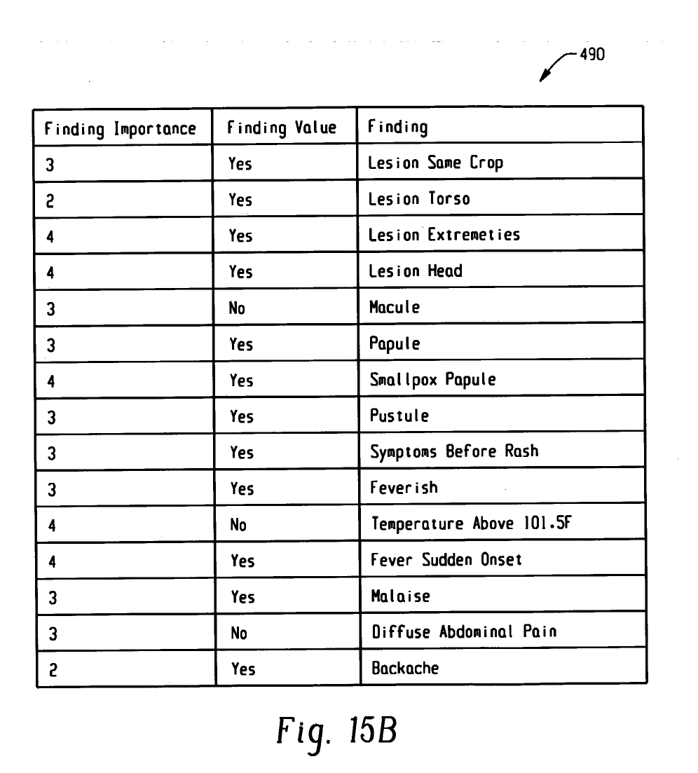

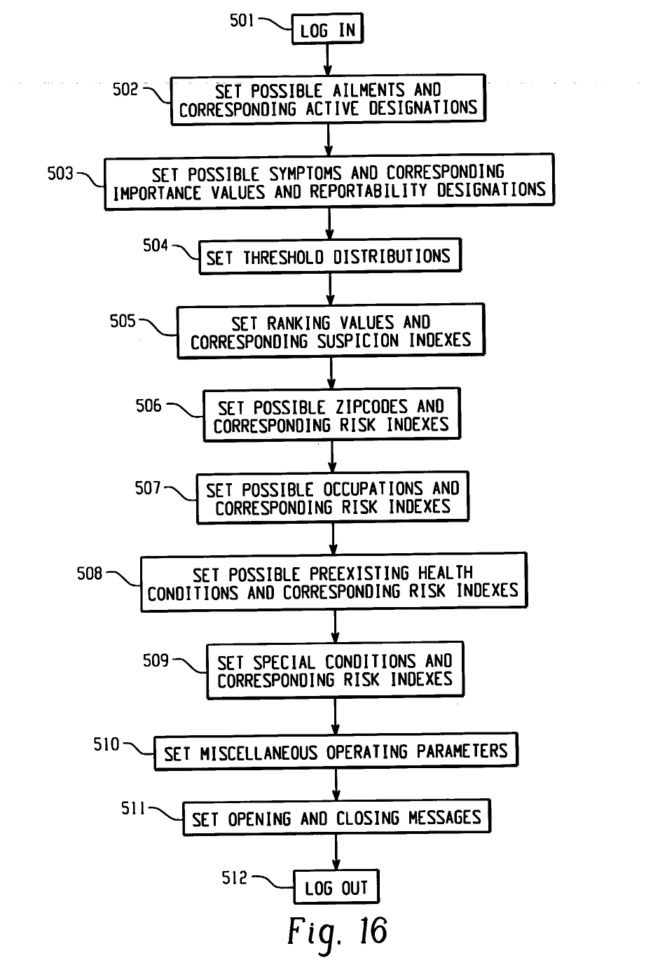

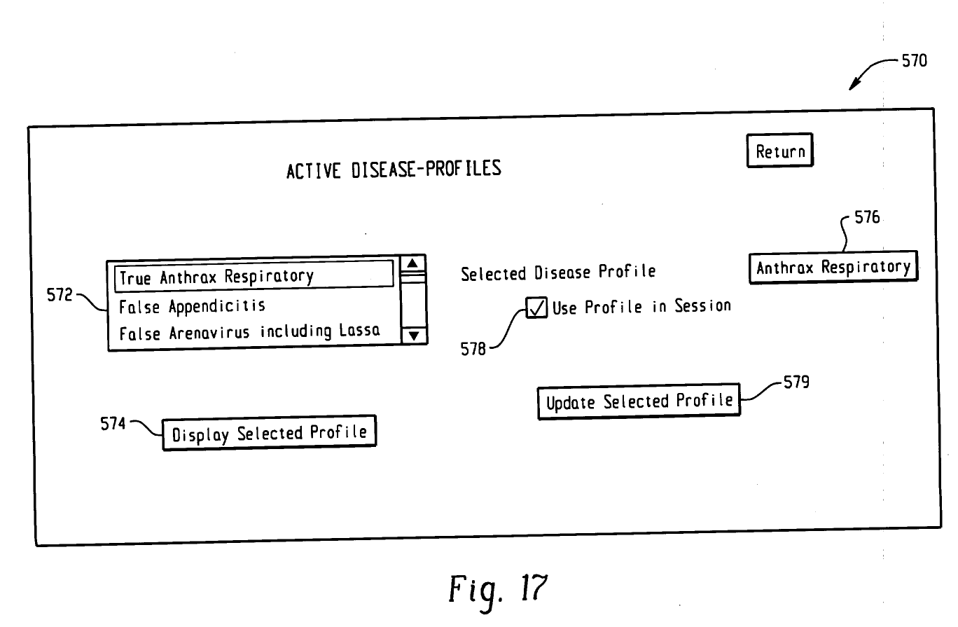

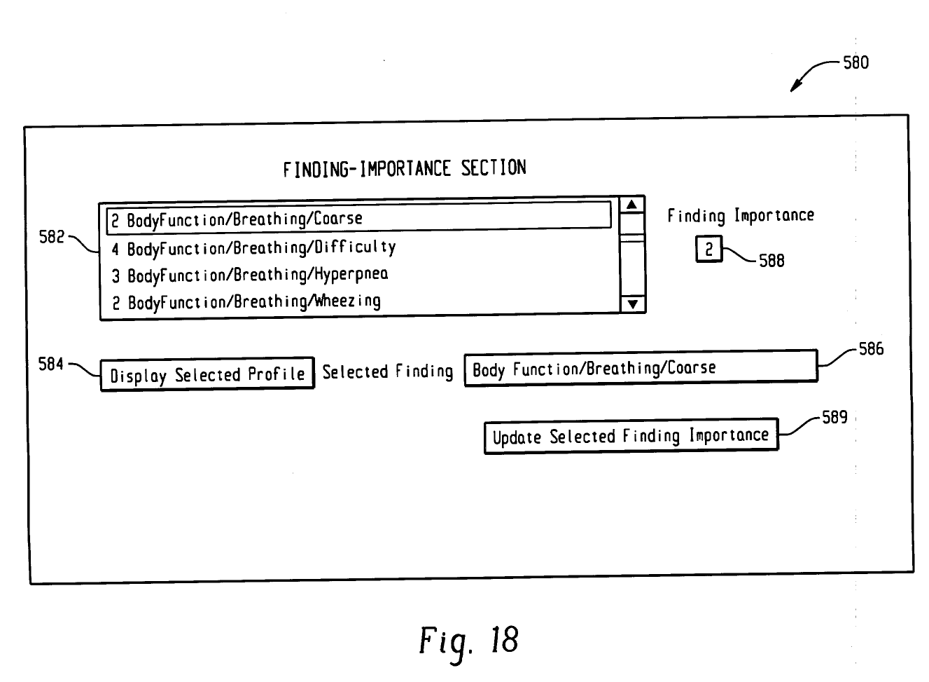

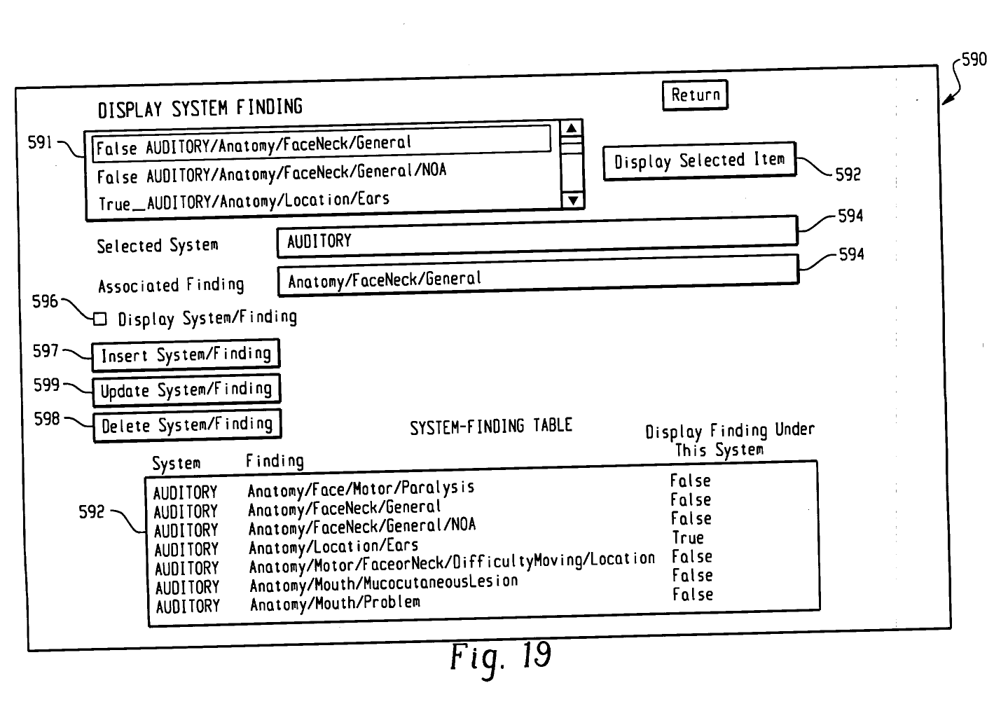

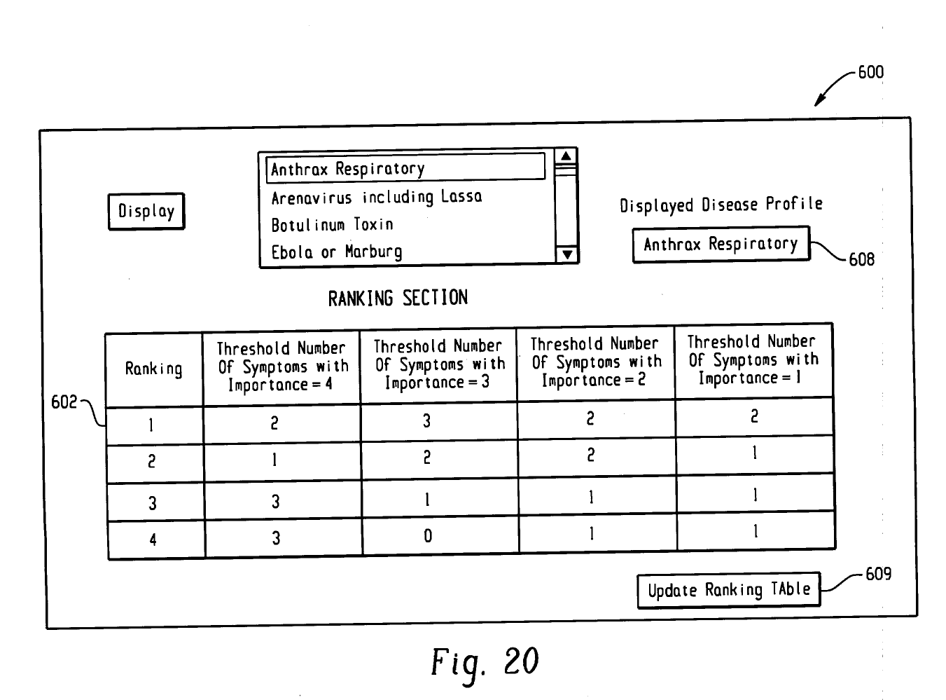

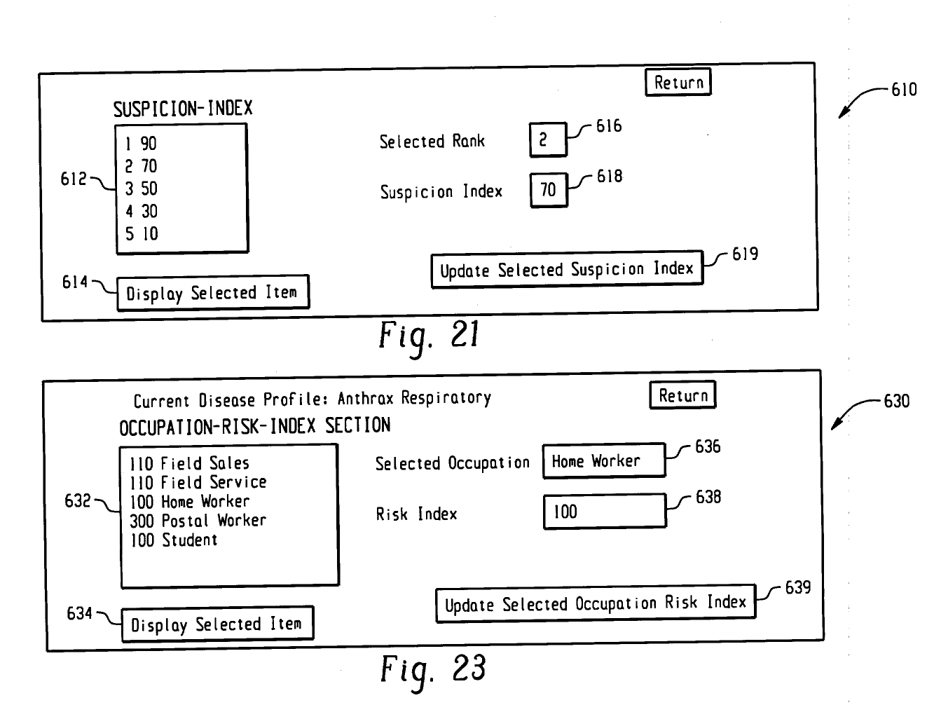

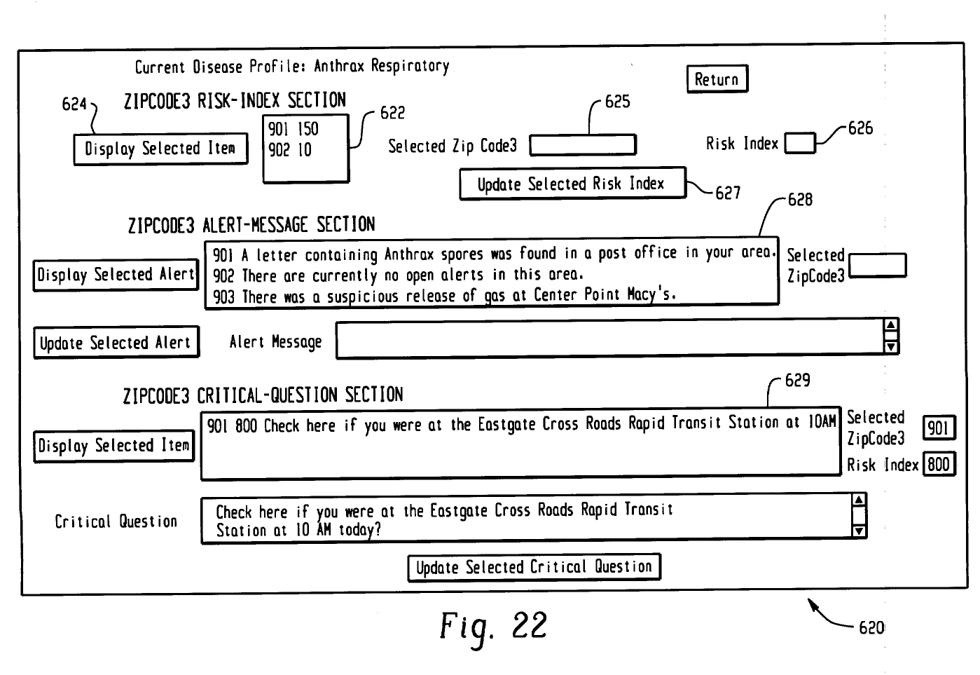

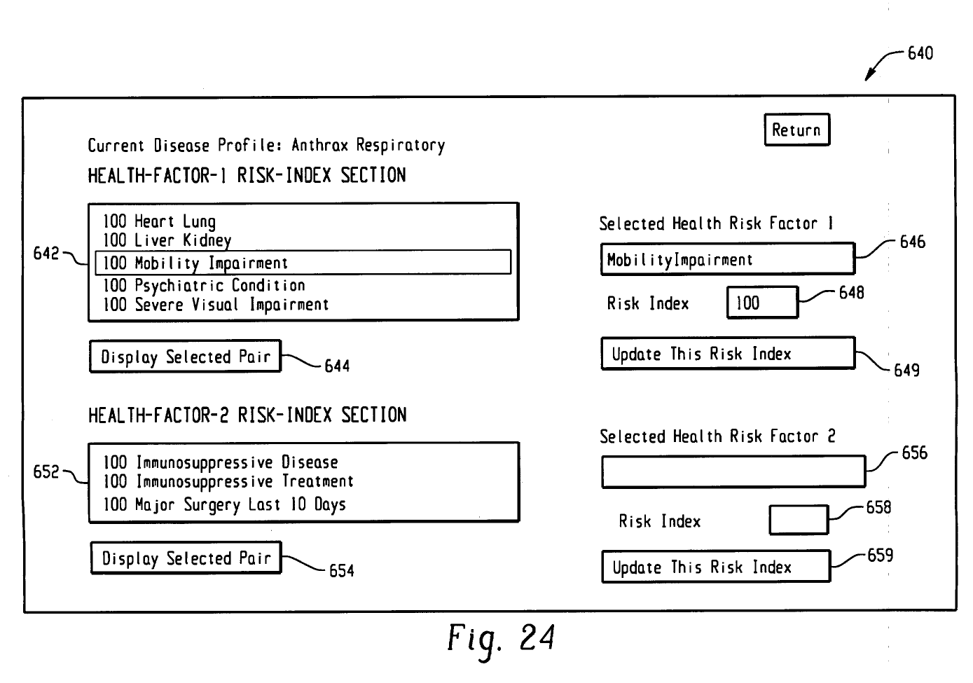

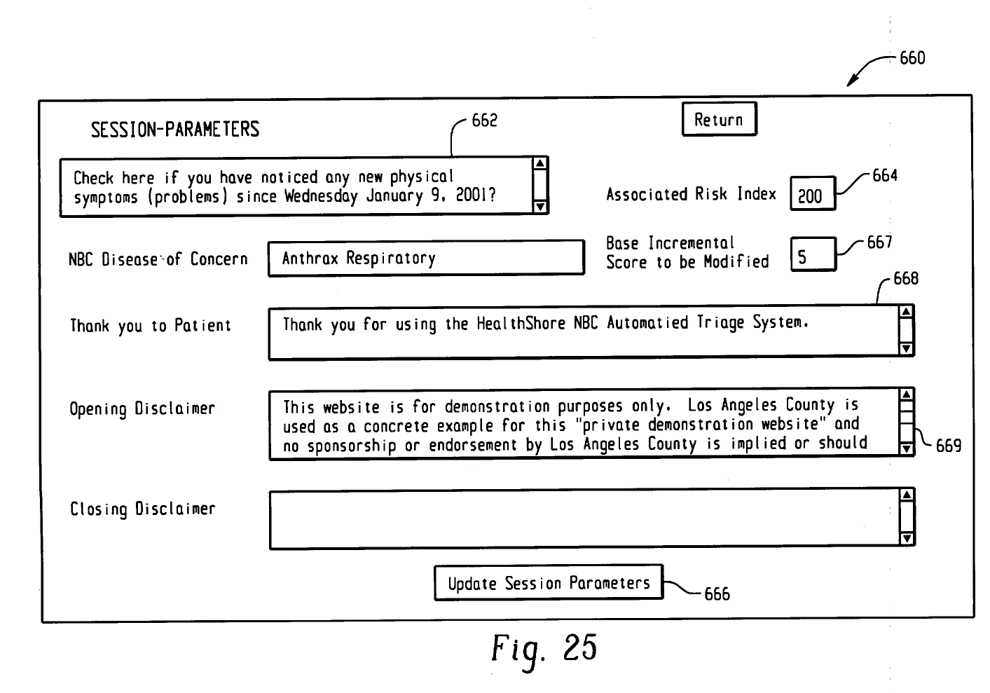

FIGS. 15-25 are web pages produced during the process of FIG. 16.

### DESCRIPTION

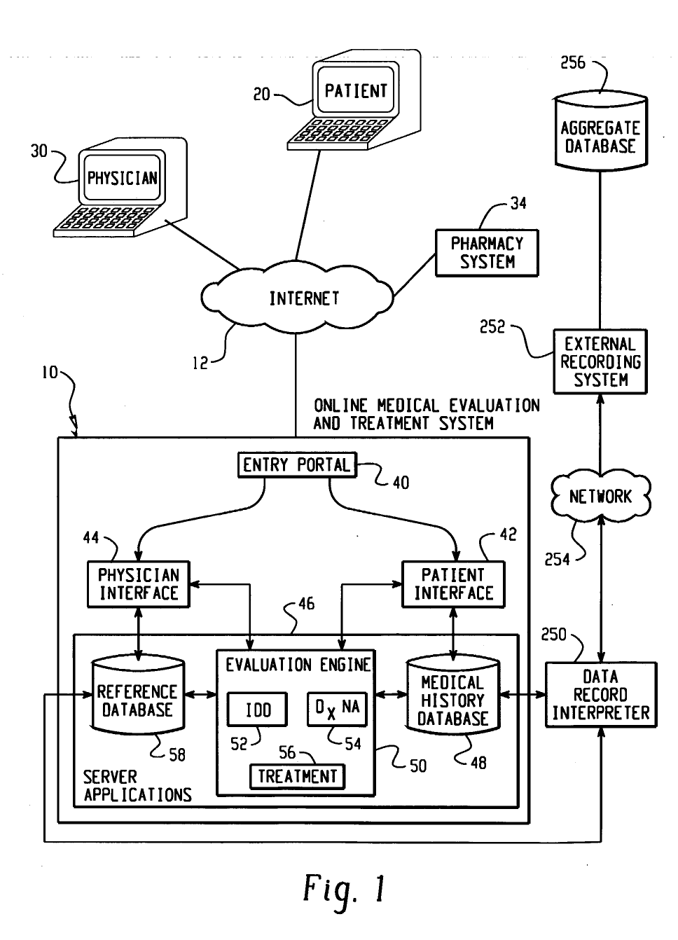

Turning now to the drawing figures, FIG. 1 is a system diagram of an online medical evaluation and treatment system 10 according to a preferred embodiment of the present invention. Through the system 10, an external user (i.e., patient 20) can access a medical diagnosis and treatment system 10 that implements time leveraging strategies to minimize physician-patient interaction time. The patient first interacts with the system 10 to define a medical condition. A physician 30 can then interact with the patient 20 once the medical condition has been, at least partially, defined. Using the system 10, the physician 30 decides upon a diagnosis and prescribes a treatment. Once the physician 30 has prescribed a treatment to the patient 20, then the treatment protocol can be sent to the patient 20 and also to a pharmacy system 34. The pharmacy system 34 can then fill any prescribed medication for the patient 20. Through the system 10, the pharmacy system 34 can fill a prescription for a patient 20 automatically or manually selected based upon the patient's location. In this manner, a patient 20 can begin treatment for an ailment without visiting a doctor's office.

The system 10 is connected to the patient 20, the physician 30, and the pharmacy 34 through a data communication network 12, such as the Internet. The system 10 is preferably implemented as an online web site for communicating information over the Internet. It should be understood, however, that the principles of the present invention are not limited to any particular technological implementation, and could be implemented over other types of communication networks.

The web site 10 includes an entry portal 40. The entry portal 40 is coupled to a pair of interfaces, a patient interface 42 and a physician interface 44. Each interface 42 and 44 includes software tools that the user operates to navigate the web site 10. The interfaces 42 and 44, in turn, are coupled to server applications 46. The patient interface 42 is coupled to a medical history database 48 and an evaluation engine 50. The medical history database 42 stores the medical history of patients. The evaluation engine 50 includes an intelligent data drilling (IDD) module 52, a diagnostic numbering and assessment module (D×NA) 54, and a treatment module 56. These modules 52-56 support the physician in preparing a diagnosis by acquiring, sorting, flagging and presenting data to a physician 30 through the physician interface 44. The physician interface 44 is also supported by a reference database 58, which may include general medical research information, statistical samples, case studies of treatment regimens, physician practices, photographs and illustrations of normal and pathological anatomy, sound recordings, video recordings and relationships of symptoms to diseases. Information from the databases 48 and 58 are stored within the system 10, and are updated through external databases that are connected to the system 10 through external networking components 250-256.

A set of external networking components 250-256 are coupled to the databases 48, 58 for communicating information to facilities that could benefit from the information contained within the system 10. The external networking components 250-256 include a data record interpreter 250, an external recording system 252, a network 254 to transmit the data to the external recording system 252, and an aggregate database 256 to store the information gathered from the external recording system 252.

The system 10 is preferably stored on a web server. The server preferably stores the software interfaces 42 and 44 as web pages accessible to users. The web pages of the interfaces 42 and 44 are communicated to users 20, 30 through standard Internet protocols for communicating web content, such as HTTP, TCP/IP, S-HTTP, SSL, etc. The users can thus interact with the system 10 by operating standard web browser software on their computers 20, 30, such as Microsoft's Internet Explorer® or Netscape's Communicator®.

A user 20 or 30 enters the system 10 through the entry portal 40, and is then directed to one of the distinct graphical user interface modules 42, 44, depending on whether the user is a patient or physician. This directional step is preferably accomplished by a graphical user interface that allows the user to select the user's class (e.g., patient or physician), and that then verifies the user's identity by querying for a user name and password. Alternatively, however, the directional step may be accomplished automatically, such as by reading information stored locally on the user's computer 20. For example, the system 10 may deposit a “cookie” on the user's computer during an initial registration process, where the “cookie” contains a profile of the user that includes information such as the user's class, identity and password. When the user accesses the system 10, the identity and password information are then automatically transferred to the system 10, thereby automating the login process and directing the user to the proper interface.

The physician interface 44 is the user interface (UI) that a physician navigates after he has passed through the entry portal 40. The physician interface 44 displays choices pertaining to the workload for the physician. For example, the physician may need to research a condition, interview a patient, review a patient's history, or make a patient diagnosis. The physician interface 44 displays a list of patients awaiting attention in a virtual waiting room and any other responsibilities the physician 30 needs to address. The physician 30 accomplishes these tasks through the physician interface 44 by using the tools of the reference database 58 and the evaluation engine 50 of the server applications 46. Once the research is completed, the physician 30 can then interact with a patient 20 who is using the patient interface 42 through the physician interface 44.

The patient interface 42 is the UI that a patient navigates after he has passed through the entry portal 40. The patient interface 42 displays choices pertaining to the nature of the visit. For example, the patient 20 may visit the system 10 to update his personal medical history records, schedule an appointment or referral for a non-urgent concern, meet an appointment or referral that was previously scheduled, or seek immediate care for a medical problem. For each of these cases, the patient 20 inputs data into the system 10 prior to receiving consultation time with a physician, thereby allowing multiple patients of a single physician to actively seek consultation at the same time. Within both the physician interface 42 and the patient interface 44, links are formed to the server applications 46 that provide the functional interaction between the system 10 and the physician 30 or patient 20.

The server applications 46 are stored in the server as functional applications, such as the evaluation engine 50, and as data storage applications, such as the databases 48, 58. The server applications 46 generate the content that is sent to the users 20, 30 through the interfaces 42, 44. The content of the web pages is generated using coding schemes that may include HTML, XML, Java, Javascript, VBscript, ASP, or other standard web-based coding paradigms for displaying web content through a web browser and for communicating information back and forth to users 20, 30 and to the server applications 46.

The medical history database 48 stores medical information about a patient 20 within a patient record. The database 48 is organized hierarchically. The hierarchical structure means that a patient 20 can access only the data relevant to him. This is important because patient confidentiality is strictly kept within the site. For example, each patient might be identified by a certain code (i.e., a social security number, an e-mail account, or a sequentially generated number) that is assigned once the patient has chosen a user name and password. Whenever that patient enters the site 10 again, he will only have access to the information contained within the structure assigned to that code. By linking a medical history to a static data point, like SSN or e-mail account, a user re-entering the site having forgotten a username and password previously chosen can still access the correct medical history once the static data point is determined to be accurate. Data stored in the medical history database 48 is used in the evaluation engine 50 to generate questions to send to the patient interface 42.

The evaluation engine 50 retrieves the data record for the patient 20 from the medical history database 48. The evaluation engine 50 compiles the data record to determine pertinent questions that could be asked of the patient 20 through the IDD 52 and the D×NA 54 modules. The IDD module 52 evaluates the answer to a question and determines if more questions should be asked via means such as branched chain logic. Within the DxNA module 54, a set of diagnoses are coded in accordance with their respective symptom profiles. By checking symptoms documented by the IDD module 52 against the symptom profiles for different candidate diagnoses in the DxNA module 54, an additional list of information to be gathered by the IDD module 52 is generated. The additional information can then be used in the DxNA module 54 to validate or invalidate the candidate diagnoses. The DxNA module 54 evaluates the answers to all the questions to determine what differential diagnosis can be made from the data gathered.

For example, if the medical history database 48 contains information indicating that the patient 20 has had an appendectomy, the IDD module 52 will not question the patient 20 about problems and symptoms that are only applicable to appendicitis. Similarly, the DxNA module 54 rules out appendicitis from the list of differential diagnoses. The information stored within the medical history database 48 provides a background for the IDD module 52 and the DxNA module 54 to generate questions for the patient.

Once the physician 30 decides on a diagnosis from a list of differential diagnosis generated by the system 10, the treatment module 56 evaluates the pertinent data from the medical history database 48, as well as data from the reference database 58 to determine a proper treatment regimen. The treatment module 56 interprets data from the medical history database 48 to suggest possible treatments for the diagnosis selected by the physician 30. For example, a patient 20 that is allergic to penicillin should not be treated with penicillin, but may respond to ciproflaxacin. Once the diagnosis and treatment is made, a reference to the pertinent data gathered through the evaluation engine 50 for this particular patient visit is entered into the medical history database 48 and the reference database 58 for use in subsequent visits.

The reference database 58 stores medical data that is generally available to practicing physicians. In general, the reference database 58 is a compilation of reference material including statistical samples of patients, video clips, sound clips and photographs that is used to evaluate a patient's symptoms against typical symptoms stored within a symptom list for a specific disease. In this comparison, a physician can diagnose the patient 20 by evaluating how closely the symptoms match the symptom list. The database 58 can be built from known sources, such as MedLine or PubMed, and may also be built from data that is specific to the local region. For example, if a certain region has a current outbreak of the flu, for which a specific treatment is efficient at curing, the physician can find this information within the reference database 58.

The reference database 58 varies from the medical history database 48 both in structure and in content. The medical history database 48 contains individual patient data that is hierarchically structured such that a patient can only access his own personal information. The reference database 58, by distinction, is structured such that a physician 30 can access data by searching any of a number of categories. The physician might search for a typical symptom or he might search for all symptoms associated with a certain disease. The physician is thus able to search for additional diagnoses if the diagnoses suggested by the evaluation engine 50 are too complex, or there are too many pertinent negatives (i.e., symptoms that suggest a diagnosis can not be correct) found within the diagnosis.

For example, if a patient is diagnosed with chicken pox because of hive-like bumps on the skin, but has previously had chicken pox the physician 30 might review the literature and photographs of skin lesions within the reference database 58 to possibly diagnose a more exotic disease, such as small pox. Such a disease might not be entered within the evaluation engine 50 since small pox is believed to be eradicated. Since the literature contained within the reference database 58 contains historical data, pertinent symptoms can be determined from examining the results of a query for small pox within the reference database 58. If the diagnosis then became small pox, this data could be stored in the reference database 58 as a recent diagnosis, and would also be stored in the medical history database 48 under the patient's record. In this manner, the medical history database 48 stores patient-specific data and the reference database 58 stores general medical information. Both of these databases 48 and 58, however, can be appended by actions taken by the physician 30 and the patient 20. Once the records in the databases 48 and 58 are stored within the system 10, it may be advantageous to export the records to external databases that are accessible at local hospitals, medical research facilities, or other treatment facilities. Exportation of the records is performed by the external networking components 250-256.

The external networking components 250-256 are configured to isolate records for exporting, format the records into readable forms, and download information that could be useful for the physicians 30 into the system 10 or upload information from the system 10 to an external database. The external networking components 250-256 are configured to communicate with databases external to the system 10. This communication is implemented through the data record interpreter 250. The data record interpreter 250 takes the information from one database source (either the databases 48 or 58 or the aggregate database 256) and orders it so that it is similar in structure to the receiving database (the other of databases 48 or 58, or aggregate database 256).

For example, the system 10 may upload patient information to the aggregate database 256. The data record interpreter 250 may first remove personal information from the records from the medical history database 48 so that personal information is not shared unless necessary. The data record interpreter 250 sends the information from the database 48 through the network 254 to the external recording system 252. The external recording system can be an interface that determines if the information contained within the record is useful to users of the aggregate database 256. If the information is useful, then the record is stored in the aggregate database 256.

The aggregate database 256 can then manipulate the record to include the record into statistics contained within the database, keep the record as a case study, or, in the case of the aggregate database 256 being hosted by a hospital, use the information as the background medical history when the same patient is taken to the hospital. The exportation of the medical information from the system 10 can save time when the patient's medical history does not need to be re entered at a hospital, serves as a research tool, and serves as a learning tool for other physicians looking for case studies.

The system 10 may also download information from the aggregate database 256. For example, if a patient 20 has recently undergone a surgery, the system 10 may search for an aggregate database 256 (such as the database of the admitting hospital for the surgery) to retrieve the records from the surgery. The data record interpreter 250 would then generate a query to retrieve the information through the interface of the external recording system 252. The record would be retrieved through the aggregate database 256 and sent through the network 254 to the data record interpreter 250. The data record interpreter 250 then formats the record to comply with the database structure of the medical history database 48. The record of the surgery is then stored within the medical history database 48.

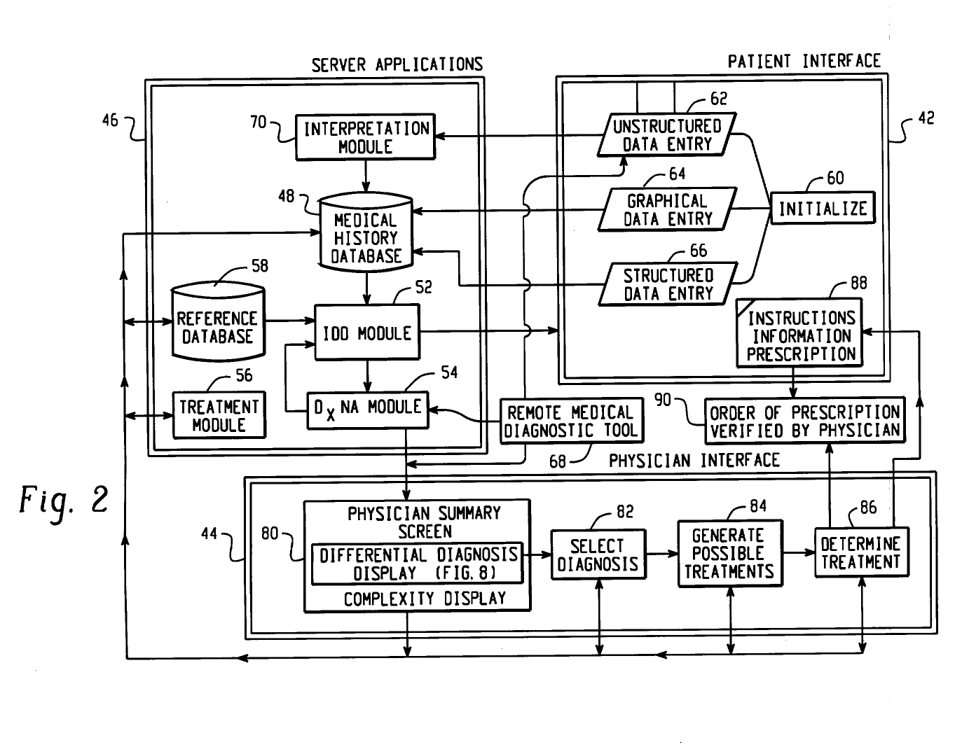

FIG. 2 is a detailed diagram of the patient interface 42, the physician interface 44, and the server applications 46 shown in FIG. 1. This figure shows the processes of data entry in the patient interface 42, data manipulation in the server applications 46, and data summary in the physician interface 44.

The patient interface 42 is initialized 60 when a patient 20 enters the patient interface 42. Data is then entered by the patient 20 through one of three entry modes: (1) an unstructured data entry mode 62; (2) a graphical data entry mode 64; and (3) a structured data entry mode 66. The unstructured data entry mode 62 collects data that is not confined to predetermined answers. For example, the patient may be asked to generally describe the ailment in a few sentences. The graphical data entry mode 64 is presented through a graphical interface that the patient 20 can manage to focus the diagnostic discussion to a particular body region. The graphical interface preferably includes figures representing regional body portions and figures that include very detailed schematics. The structured data entry mode 66 includes questions where the patient chooses from a list of predetermined answers. For example, the patient 20 may be discussing his diet and may choose from a list that included: meats, vegetables and dairy; no red meat; vegetarian with dairy; vegetarian non dairy; or vegetarian with dairy and fish. The patient 20 may then describe his diet by choosing one of these predetermined categories. Each of these data entry modes 62-66 can query the patient 20 individually or combine certain aspects of different entry modes to query the patient.

After the patient passes through the entry portal 40, the patient interface 42 is initialized 60 by recalling the data that the patient previously entered into the site 10 and which is stored in the medical history database 48 and by configuring the interface 42 to match that data. For example, if the patient 20 is male, the system 10 would load male figures into the graphical entry mode 64. Similarly, other graphical displays that depict specific figures that are appropriate for the specific patient 20 can be displayed, such as wheel-chaired figures or figures having certain disabilities. The system 10 also loads the patient data from the medical history database 48 during initialization so that questions will not be redundant. If this visit is the first visit of the patient 20, then the initialization step 60 queries the patient 20 for family history and personal medical history information. In subsequent visits, these background queries are not repeated. The interactive patient interface 42 then proceeds to query the patient regarding the specific medical reason for the visit using the entry modes 62-66 to collect data.

Initially, the system 10 presents symptomatic questions that broadly define the problem and then narrowly focus in on the particular medical illness. For example, when a patient enters the site because of an illness, the unstructured data entry mode 62 may first ask the patient 20 to describe the illness in a brief one or two sentence statement. The graphical data entry mode 64 may then display a picture of a body that the patient can manipulate in order to pinpoint the particular area of the body which may be causing pain. Finally, a set of structured questions presented through the structured data entry mode 66 can focus the inquiry on the types of pain, frequency and how long the pain lasts. Other questions could arise such as changes in daily routine, medications taken, tone and color of the affected region, etc. The use of the structured data entry mode 66 enables very detailed questions.

The structured data entry mode 66 queries the patient 20 for information by providing a structured list of answers to a question. The structured list may contain choices for yes and no, or a series of choices where the patient 20 chooses at least one answer. For example, a patient 20 who complains of difficulty breathing might be asked, “Is your cough productive (produce sputum)?” Possible answers are “yes”, “no” or “I don't know.” If the answer is “yes,” then the next question could be, “What color is the sputum?” Answers for this question could be: yellow, white, clear, red with blood, or pink and frothy. Most likely, this question will also have a single answer. But a question such as “When does your shortness of breath occur?”, may require the patient 20 to choose any or all of these answers: sleeping, active, resting.

Since the structured questions may be answered with one or more answers from a list, the structured data entry mode 66 presents the choices in a manner consistent with the ability to choose just one, or many answers from the list. This structured list thus could be presented to the patient 20 through pull down boxes, radio buttons, check boxes or other structured means. The patient 20 then chooses the best answer from this structured list. The answer is then used to generate the next question, as shown above in the sputum questions. The question can either be on the same topic or on a different topic based on the previous answer. Through the use of the structured data entry mode 66 the patient 20 can choose an answer from a standardized list instead of trying to create his own descriptive terms.

Similar to structured data entry mode 66, the graphical data entry mode 64 can display a series of pictures as a structured list. The standardized choices and use of pictures to describe the question reduces vernacular terms that a patient 20 might use and replaces the vernacular terms with standardized terms that physicians use to describe symptoms and conditions.

The graphical data entry mode 64 can be used to display pictures of ailments. For example, if a patient 20 is complaining of a skin rash, the graphical data entry mode 64 could include pictures of common types of rashes, as shown on other patients, or as a medical diagram. Similar to the structured data entry mode 66, the graphical data entry mode 64 thus can provide descriptive graphical data that the patient 20 can choose instead of asking a patient 20 for descriptive terms.

For example, a patient 20 may have a raised irritation on the skin. Possible diagnoses could be a cyst, a blister, or a pustule such as acne. By showing pictures of each of these skin ailments to the patient 20, the system 10 can differentiate the three ailments more quickly than a set of questions could. The patient 20 would then realize a cyst is an elevated, encapsulated lesion, a blister is a vesicle that can be greater than 1 cm in size and is generally filled with a clear liquid, and acne is similar to a blister but filled with a purulent fluid.

The unstructured data entry mode 62 includes questions that seek descriptive terms or phrases that a physician 30 can interpret. Most of the questions within the unstructured data entry mode 62 are used to validate the answers provided in the structured and graphical data entry modes 64 and 66. The unstructured answers are also searched for terms that can be used to suggest certain types of questions. For example, a patient 20 complaining of a rash would generally use words such as “skin,” “rash,” or “itchy” as terms in a short description of the ailment. The system 10 would interpret these words and then compile questions directed to the integumentary system.

Another form of data that may be entered through the unstructured data entry mode 62 includes physiological data captured at the location of the patient. The physiological data can be gathered through the use of a remote medical diagnostic tool 68. The remote medical diagnostic tool 68 could be, for example, an EKG monitor that monitors the electrocardiographic signal of the heart. The output of the diagnostic tool 68 could be coupled to the computer of the patient 20 through a serial port, USB port, or any other type of connection. The EKG would represent raw data that could be used by the system 10 to diagnose a heart condition. The data could be examined and/or integrated by the system 10 in order to generate questions, or so that the raw data can be displayed to the physician. Finally, unstructured data can be input into the system 10 through the diagnostic tool 68 via a sound file. The patient 10 may record a cough, or some other sound, through a microphone that can then be entered into the site through the unstructured data entry mode 62. The data gathered through the data entry modes 62-66 is passed to the server applications 46 for examination and storage.

The server applications 46: (i) process and store the data passed from the patient interface 42; (ii) communicate back to the patient interface 42 with additional questions, and (iii) compile summary information for the physician interface 44. The server applications 46 include an interpretation module 70 configured to translate unstructured data from the patient interface 42 into structured data. The medical history database 48 and the reference database 58 store the data from the patient interface 42 and the interpretation module 70. The IDD module 52 and the DxNA module 54 process the information from the patient interface 42 and the databases 48 and 58. The IDD module 52 also queries the patient interface 42 with additional questions. The DxNA, IDD and medical history database modules are also responsible for generating the summary information for the physician interface 44. Finally, the treatment module 56 processes information from the databases 48, 58 to determine treatment protocols.

The medical history database 48 is structured to receive structured data from either the structured data entry mode 66 or the graphical data entry mode 64 from the patient interface 42. Unstructured data captured through the unstructured data entry mode 62 first passes through an interpretation module 70 which analyzes the unstructured data and reduces it to a structured data form that is fed into the medical history database 48. For example, if the patient is asked to describe the chief complaint for the visit, and the answer given is, “Something is wrong with my eyes, they water a lot,” a structured entry to the medical history database 48 that corresponds to this unstructured input might be, “Complaint: Watery eyes.” This structured entry can be both a title for the complaint, and a beginning point to start questioning the patient 20.

If the patient 20 also had a diagnostic tool 68 for measuring sensitivity of the eye to light, then the patient may also input his eye's response to light. This responsive input could be a video clip, such as an MPEG, of changes in iris size based on a known lumen source. The interpretation module 70 may then determine if the eye is not responding normally to the light source by examining and analyzing the data contained within the video clip. The structured information sent to the medical history database 48 in response to this unstructured input may then be “an abnormal response to light” instead of the raw data of the MPEG. In this manner the interpretation module 70 can process textual unstructured data as well as data from diagnostic tools 68. The structured data can then be saved in the medical history database 48 and passed to the IDD module 52 or the DxNA module 54. Furthermore, it may be necessary to store the unstructured data. The database 48 can link to the files storing unstructured data, or cells within the database 48 may be configured to handle the unstructured data.

The IDD module 52 retrieves data from the medical history database 48 and the reference database 58 to determine pertinent questions for the patient 20. The information gathered from the medical history database 52 is primarily the background information entered during the initialization step 60, as well as information from any prior visits to the system 10 for medical treatment. The IDD module 52 begins with a set of general questions. These general questions seek to define, in the broadest sense, the health problem of the patient. For example, the IDD module 52 may initially generate questions to determine the frequency and magnitude of the health problem.

Example General Questions Could be:

1. Is this the first time this problem has occurred? (Yes/No)
2. Did you receive medical treatment the last time it occurred? (Yes/No)
3. What was the treatment? (Pull down box of medications and treatments)
4. The onset of the problem began (hours/days/weeks/months) ago.

5. The problem occurred at: (Work/Home/Traveling)
6. Are your symptoms (Intermittent/Constant)
7. How frequently does this problem occur? Per (minute/hour/day/week/month)
8. Is there a variation in symptoms between attacks (yes/no)

Once the patient 20 answers question 1, then he is asked question 2 only if the answer to question 1 is “no.” Similarly, question 3 is asked only if the answer to question 2 is “yes.” If the answer to question 1 is “yes,” or the answer to question 2 is “no,” then the IDD module 52 generates question 4. If the answer to question 6 is “intermittent,” then the IDD module 52 generates questions 7 and 8. This process of drilling down through questions may continue for a plurality of levels via means such as branched chain logic. The answers to these questions are stored in the medical history database 48 as the patient 20 answers them.

The answers provided in response to these levels of questions are stored in a similar structure as the structure that stores the questions within the IDD module 52. Thus the medical history database 48 is structured so that if the answer to question 1 is “no,” then a layer within the patient's database record is created to store the answer to question 2. Once the general questions are exhausted, the IDD module 52 begins reviewing physiological systems that are related to the problem. Such system questions include general system questions that determine the general, current, overall health of the patient 20, and specific system questions that determine the specific characteristics of systems such as skin, gastro-intestinal, or urological, based on the chief complaint.

The IDD module 52 generates general system questions regarding the general state of health of the patient prior to the current medical condition. These questions put the health of the patient 20 into context. For instance, it is important to know if a patient 20 has recently been exposed to infectious or contagious diseases, or has traveled abroad. Other general system questions that may be appropriate seek to define symptoms such as fever, chills, pain type, etc. These questions and corresponding provide information the system can use to answers begin to focus on the exact nature of the medical problem.

Once the general system questions are completed, the IDD module 52 then builds the specific system questions, for example, relating to the skin, the musculoskeletal system, the digestive system, or any other systems of the human body. These more specific questions are presented to the patient 20, and then further questions are built within the IDD module 52 based on the answers to these specific system questions in order to seek more detailed information regarding questions that are answered with an abnormal response. Abnormal responses are determined by checking the patient's answers against common answers contained in the reference database 58. The reference database 58 is thus used as a check against the answers of the patient, and as a knowledge base to generate further questions. Once the general and more specific system questions have been answered by the patient 20, then the DxNA module 54 assesses the information from these answers.

The intelligent medical interview can be targeted against a specific target disease (such as smallpox in the case of a bioterrorism attack) or to develop a differential diagnosis relating to two or more candidate diseases. Frequently, the approach where one disease is targeted is preferable since trying to pull out a rare disease from a lot of common diseases is difficult.

Interviews are conducted in two phases. In the first phase, IDD Module 52 presentations general screening branched-chain set of questions not meant to cover every condition that a person could have but generating data relative to a nuclear, biological, chemical, or other designated category of condition. Use of branching insures that not all potential questions are asked. Thus if the answer related to the topmost line of questioning is no (say, do you have any skin problems), then no more questions are asked within that category. This would not preclude putting in a related question later for consistency checking. During the first phase, findings related to one or more specific disease profiles are filled in.

Each finding has an associated finding importance value (say on a scale of 1 to 4). At the end of the first phase, target disease profiles have their findings checked and if a given threshold is reached (say two or more findings are present with finding-importance values of 3 or more), then the second phase of questioning, DxNA Module 54 is triggered. Each finding in a disease profile has a question associated with it. Questions related to findings for which no finding value exists are then asked. In addition, a mechanism is in place to prevent questions being asked that should not be asked because the finding related to a parent or a sibling finding would logically preclude doing so. Thus for example, if the answer to having a skin lesion of a given type is no, then the questions related to eliciting the specific features of that type of skin lesion are not asked.

The DxNA module 54 retrieves information stored within the medical history database 48 and generates a preliminary list of possible diagnoses based on the answers supplied to the IDD module 52. This list of possible diagnoses is referred to as the differential diagnosis. The DxNA module 54 weighs the symptoms presented within the answers to the questions from the IDD module 52, and then matches the magnitude and frequency of the symptoms presented against known characteristic symptoms of various medical conditions. The results are weighted consistent with the seriousness of individual symptoms. From the weighted results, the differential diagnosis is made. The differential diagnosis can include multiple diagnoses arranged based on the likelihood that a particular diagnosis is the correct diagnosis (i.e., based on the value of the cumulative weighted results of the symptoms expressed by the patient 20).

A threshold, either in the number of diagnoses kept or as a minimum of the weighted result for a possible diagnosis, is set to limit the number of diagnoses reported to the physician 30. The threshold is set so that a sufficient number of diagnoses are kept within the differential diagnosis. In this manner, a physician 30 examining the results can choose between a set of diagnoses and may generate other questions that may be important in making a proper diagnosis. The differential diagnosis is also used to determine if any more questions are necessary.

Once the preliminary differential diagnosis is generated, the DxNA module 54 then uses the information gathered through the IDD module 52 to determine if more questions should be asked by testing the diagnoses. These questions are based on information stored within the DxNA knowledge base 180, the IDD knowledge base 170, reference database 58 that pertains to the diagnoses included in the differential diagnosis. For example, a diagnosis that includes a urinary tract infection (UTI) may require additional answers to questions within the urological system. Some of these questions may have been skipped in the initial screening, but can be asked when the diagnosis is narrowed to a set of candidates. The additional information fills in the information necessary to further narrow the list of candidate diagnoses. Once the additional information suggested by the DxNA module 54 is gathered through the IDD module 52, then the DxNA module 54 again generates a refined differential diagnosis that may contain some of the same diagnoses as before and any new diagnoses that are possibilities based on the symptoms presented. This process of looping through the DxNA module 54 and the IDD module 52 may be continued until no new diagnoses are generated within the differential diagnosis, or until some predetermined number of loops have been executed. The final results are then prepared for the physician interface 44.

The physician interface 44 retrieves information from the DxNA module 54, IDD module 52, medical history database 48 and may also retrieve data from diagnostic tools 68 that record data from the patient 20. The information gathered from these sources is presented to the physician 30 on a physician summary screen 80. The physician 30 interacts with the physician summary screen 80 as follows. First, the physician 30 reviews the information in the physician's summary, then he determines a diagnosis and submits the diagnosis on a select diagnosis screen 82. The physician interface 44 receives the diagnosis, searches the treatment module 56 for treatments for the medical condition determined in the diagnosis, and then displays the treatment results in a possible treatments screen 84. The physician 30 may then choose the treatment protocol from the possible treatments screen 84, and then finally, the physician 30 may enter the treatment in a determine treatment screen 86.

An email posting to a secured web space 88, or other form of correspondence, may then be sent to the patient 20 once the treatment is determined. If the treatment requires a prescription, then an order for a prescription 90 can be verified by the physician 30 at a drug store through the pharmacy system 34. The physician/patient visit is then concluded. Any additional instructions for follow up visits or referrals to a specialist could be included in the correspondence 88.

The physician summary screen 80 reduces all the collected information into the most pertinent information that the physician 30 then reviews to make a diagnosis. This screen 80 is generally the first introduction the physician 30 has to the patient 20. Prior to interacting with the patient, the system 10 has received and recorded the information via the interactions described above, compiled the information, and then prepared it for presentation to the physician in the summary screen 80. This is an important aspect of the system 10, because these patient interaction steps free the physician 30 from the data gathering portion of the visit. This allows the physician 30 time to treat more patients 20.

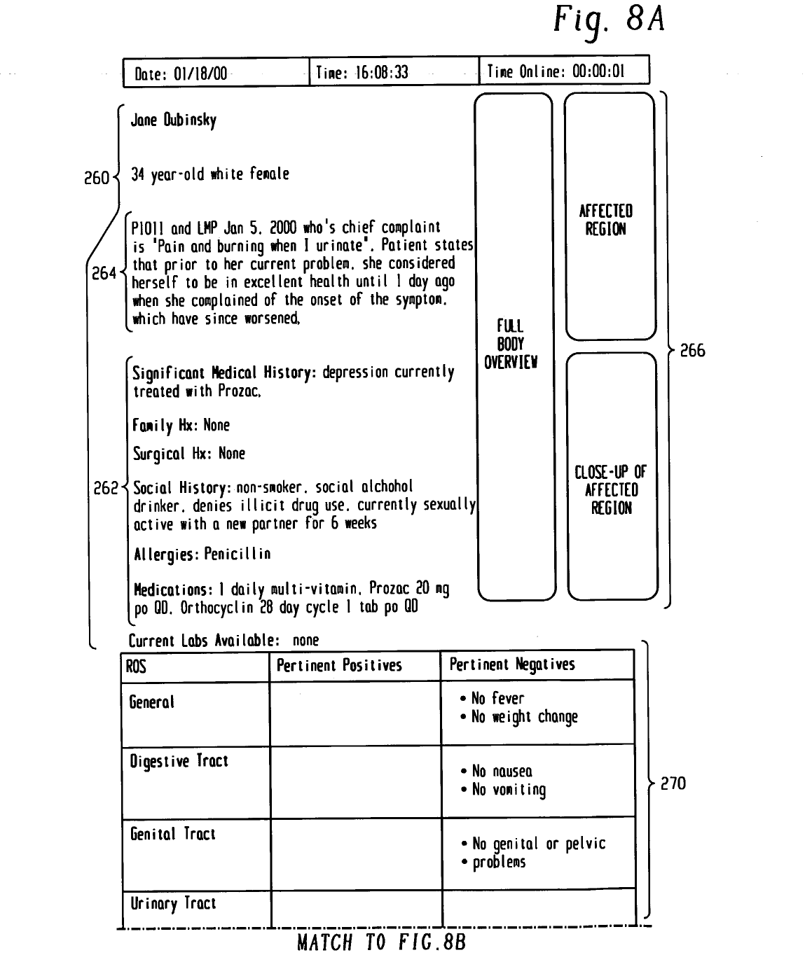

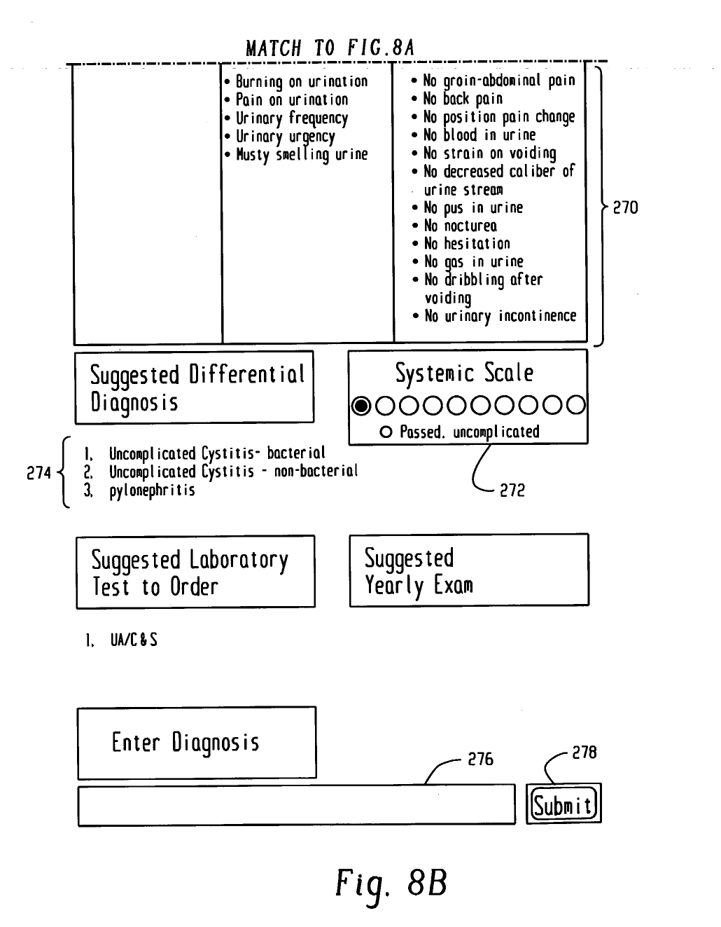

The physician summary screen 80 also displays all the pertinent information that the system 10 has reviewed to make a differential diagnosis. This again saves the physician 30 time by removing any duplicate data or unimportant information and logically ordering the data into a structured summary. The physician 30 can review the material presented in the summary 80, ask for additional data from diagnostic tools 68, and review the patient's medical history stored in the medical history database 48. These functions are tools a physician 30 uses to interact with the patient 20. The content of the physician summary screen 80 is discussed in more detail with reference to FIGS. 8A and 8B. The physician summary screen 80 also may include a case complexity indicator. The case complexity indicator, also discussed in FIGS. 8A and 8B, is a measure of the complexity of the patient's medical problem. The complexity is measured by the systemic interruption of normal activity that the patient experiences. Once the physician has interpreted and clarified the results shown on the summary screen 80, the physician 30 advances to the select diagnosis screen 82.

The select diagnosis screen 82 is an interface where the physician chooses either one of the diagnoses suggested in the differential diagnosis or determines a diagnosis separate from those included in the differential diagnosis. Once the diagnosis is chosen, the system 10 sends the diagnosis to the medical history database 48 to be stored in the patient's record and also to the reference database 58 as a possible case study for future diagnoses. Having selected a diagnosis from the select diagnosis screen 82, the physician then views possible treatments generated via the treatment display 84

The treatment module 56 processes the patient's record to check for allergies or other medical history pertinent to the treatment, and also reviews treatment protocols within the reference database 58. The treatment module 56 then sends possible treatments to the generate possible treatments screen 84.

The possible treatments 84 are displayed for the physician 30 within the physician interface 44. The possible treatments are checked for side effects and are also checked to see if they interfere with other drugs. The physician 30 then determines if the patient 20 is allergic to any particular drug or if a drug has produced bad side effects in the past. The treatment could also include a number of medications to which the physician 30 must assure himself that the patient 20 has the mental capacity to manage. Once the physician 30 is satisfied with a treatment, the treatment is entered on the determine treatment screen 86. Finally, the treatment choice and the accompanying instructions are communicated to the patient 20 via the e-mail 88 or other means of communication. The patient 20 may then send the order to a pharmacy 90, which may verify the medication through the physician 30.

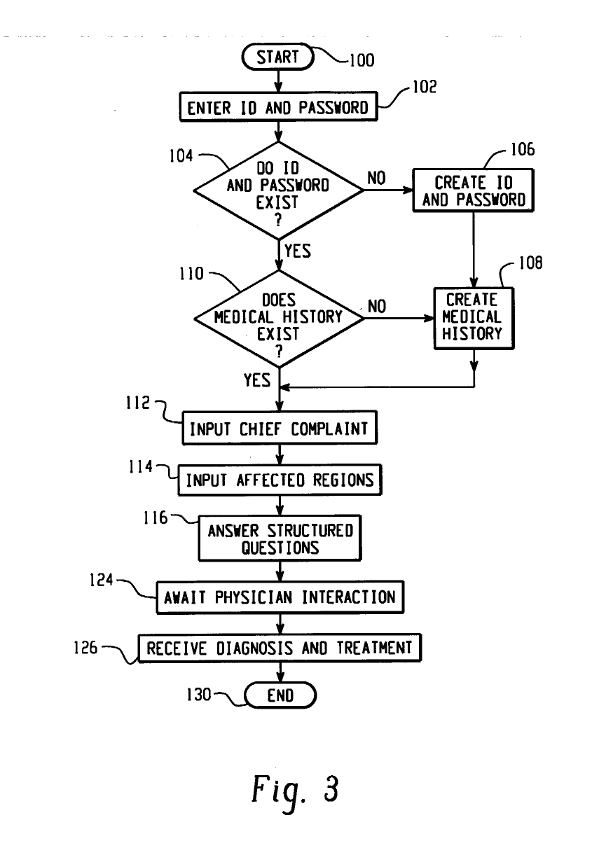

Turning now to FIG. 3, a logical flow chart is set forth showing the preferred steps enabled by the patient interface 42 of the present invention. These steps are implemented when a patient 20 seeks a medical consultation via the system 10. The process starts at step 100, when a patient 20 enters the site 10. The patient 20 then enters an ID and password at step 102. The system 10 then determines if the ID and password exist at step 104. If the ID/password combination does not exist, then the system 10 creates the ID and password at step 106, and then queries the patient 20 to create a medical history in step 108. If the ID and password exist, however, then the system 10 determines if the medical history of the patient 20 has been entered into the medical history database 48 in step 110. If the medical history does not exist, then the patient 20 is queried to create the medical history in step 108. Once the medical history is created, the patient 20 then inputs a chief complaint in step 112. The patient 20 then inputs the affected regions in step 114, and answers structured questions in step 116. Once the structured questions have been answered, the patient 20 awaits physician interaction 124. The physician 30 then diagnosis the patient 20 and prescribes a treatment in step 126. The patient exits the site 10 in step 130 after the treatment regimen has been received.

Within these steps 100 through 130, the patient 20 does not generally proceed until information at any step is fully gathered. This process allows the physician 30 to see the patient's case entirely when he begins his consultation. Importantly, this saves the physician 30 time since the physician 30 is not required to gather data during the consultation. The physician 30 can, however, further inquire about the data that has been gathered by questioning the patient 20 as the diagnosis is being made in step 126.

For example, a first time patient enters the system 10 seeking a diagnosis for a cough. Since an ID and password do not exist yet, the system 10 creates the ID and password 106. At this point, the medical history database 48 is also appended to include a new record for this patient. The system 10 then queries the patient for a medical history, and saves the medical history information to the patient's record in the medical history database 48. The create medical history step 108 requests personal information, such as the patient's name, birth date, height, weight, sex and address, and medical information such as family history. Once these preliminary steps 100-110 are completed, the patient begins to enter his complaint into the system.

The patient begins with a simple explanation of the medical problem in step 112, such as, “I have a cough that has become painful and as a result I have lost my voice.” The patient then uses a mouse or other pointing device associated with his computer to pick the throat and head region of the body using the graphical data entry means 64. Additional graphical diagrams may also be presented by the system 10 so that the patient can zoom in closer on the throat and head portions of the body in order to more precisely indicate the problem area. The choices made by the patient in interacting with these graphics serve to narrow the focus of the questioning that the IDD 52 presents to the patient in step 116.

The IDD 52 generates the questions that the patient answers in step 116. The patient continues to answer questions until the present iteration of questions from the IDD 52 is exhausted. It is important to note that the questioning steps 112-116 can be rearranged and revisited. The IDD 52 may find additional graphical material for the patient to answer after step 114 has been passed. Also, additional material such as a sound file of an exemplary cough might be requested at some point during the questioning steps 112-116.

Once the questioning steps 112-116 are completed, the patient waits for a physician 124 in a virtual waiting room. While waiting in the virtual waiting room, the system 10 may present informational material for the patient to review, such as physician biographies, general medical information, links to goods and services that may interest the patient, or games to occupy time. Once the physician is ready to review the case, the system 10 notifies the patient in the virtual waiting room, and the patient then begins to receive the diagnosis and treatment for the ailment directly from the treating physician.

The consultation step 126 may include numerous interactive tools. For example, the physician 30 may e-mail the diagnosis and treatment, or the system 10 could engage a videoconference link between the physician and the patient, or the physician could engage the patient in a telephone conversation, or the physician could send an instant message to the patient through an online service such as AOL Instant Messenger, ICQ, Yahoo! Messenger. During this interaction, the physician 30 explains the diagnosis and the prescribed treatment.

The steps 100-130 in FIG. 3 generally describe a patient's visit to a physician via the system 10. It should be understood, however, that this flow chart may include other steps for other types of patients. For instance, a child who can not enter the necessary information into the site 10 can have a proxy, such as a parent, enter the appropriate information and otherwise interact with the system. Similarly, older patients, or handicapped individuals, may use the assistance of a caregiver to enter information into the site 10. In these instances, the ID and password are assigned for the patient and not the proxy.

Importantly, the steps 100-130 for the patient 20 are similar to the experience of a visit to a physician's office. In this experience, the patient 20 first fills out a general history sheet, is then taken to a room for routine questioning, likely by a nurse, and is then questioned by a physician as to the specific reason for the visit. The physician then leaves to review the results of the questioning and finally diagnoses the condition and suggests a treatment which is explained to the patient. The system 10, however, uses the server applications 46 to leverage the time required to treat the patient, thereby enabling the physician to complete the diagnosis and treatment of a patient in a fraction of the time associated with the traditional office visit.

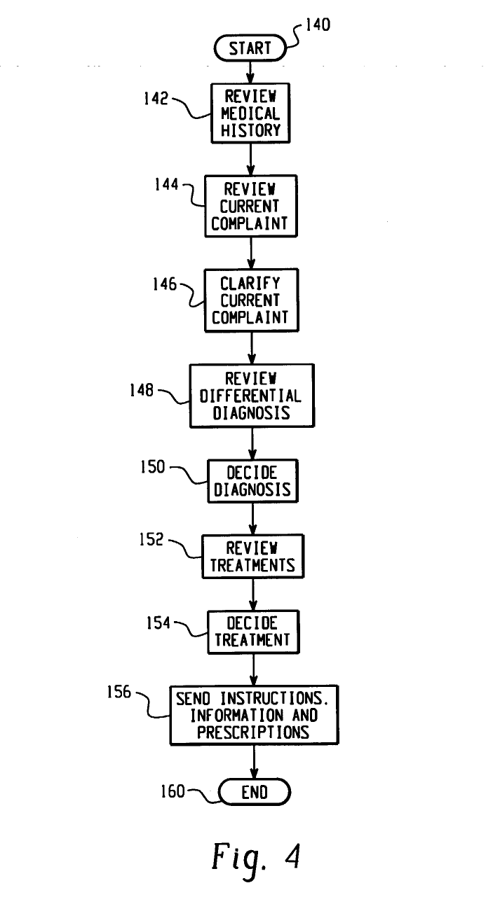

Turning now to FIG. 4, a logical flow chart is set forth showing the preferred steps enabled by the physician interface 44 of the present invention. When the physician 30 enters the system 10, he logs in at the entry portal 40 and is then directed to the physician interface 44, where a list of patients who have completed interacting with the data gathering modules is waiting. The physician selects a patient to exam, then begins the evaluation process at step 140. The physician 30 reviews the patient's medical history of the current case at step 142. The physician then reviews the current complaint at step 144 and clarifies the complaint in step 146. Once the physician is confident that he understands the problem, he then reviews the differential diagnosis made by the system 10 in step 148. In step 150, the physician then decides which diagnosis is correct, or, alternatively, he selects another diagnosis that is not included in the differential diagnosis. Once a diagnosis is chosen, the physician then reviews treatments for the diagnosis in step 152. A treatment is decided at step 154, and then information, instructions and prescriptions for the diagnosis are sent to the patient in step 156. The physician completes these steps and the process ends in step 160.

FIG. 4 generally shows the steps a physician takes in diagnosing a patient. Importantly, these steps are carried out in such a way as to save time for the physician. The physician does not have to collect the information from the patient regarding his current medical condition because most of this information was previously collected from the patient during the initial patient interaction with the system 10. The system 10 leverages the physician's time to maximize the number of patients that can be consulted in a given time period. The physician's time is maximized by reducing the physician's work load to include the most crucial steps in diagnosing the ailment, and prescribing the treatment while automating the more basic data gathering steps.

The flow chart of FIG. 4 includes review steps 142-148, decision steps 150-154, and resulting step 156. The review steps 142-148 provide a process for the physician 30 to review the medical condition and other pertinent information from the patient's past medical history. The review steps 142-148 provide time saving tools since information that is not pertinent to the case, as determined through the interaction of the IDD module 52 and DxNA module 54, is not presented to the physician 30 in the review steps 140-148. The physician 30 may also interact with the patient as necessary in the review steps by communicating with a patient as described above with reference to step 126. Within these review steps 142-148, the physician 30 may revisit the medical history records he has previously searched. Thus, the physician 30 may begin by reviewing the patient's medical history, but may then return to the medical history once he has studied the current complaint and the differential diagnosis. The information provided within these steps is contained in the differential diagnosis display of FIG. 8 and is discussed further below.

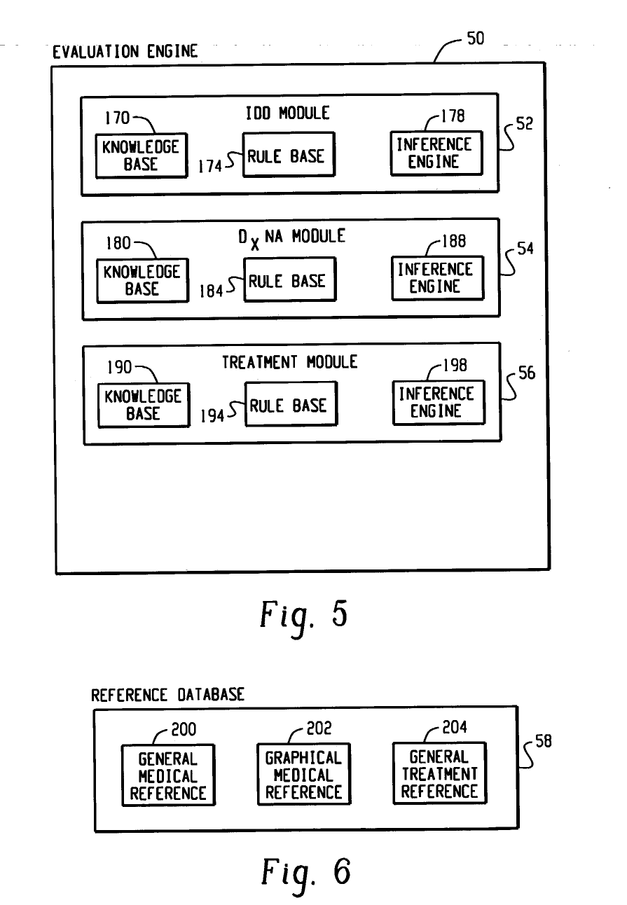

Turning now to FIG. 5, a detailed diagram of the evaluation engine 50 of FIG. 1 is provided. The evaluation engine 50 includes the IDD module 52, the DxNA module 54, and the treatment module 56. Each of these modules 52-56 includes a knowledge base 170, 180, 190; a rule base 174, 184, 194; and an inference engine 178, 188, 198. Within the IDD module 52, the knowledge base 170, the rule base 174, and the inference engine 178 are configured to generate further questions based on previous answers and reference data. Within the DxNA module 54, the knowledge base 180, the rule base 184, and the inference engine 188 are configured to generate candidate diagnoses based on previous answers and reference data, and thereby, indicate what additional information should be gathered by the IDD module 52. And within the treatment module 56, the knowledge base 190, the rule base 194, and the inference engine 198 are configured to generate treatments based on previous answers and reference data.

The knowledge base 170, 180, 190 comprises reference material from the reference database 58 and the medical history database 48 as well as specially structured data sets. The knowledge base 170, 180, 190 collects and stores relevant data regarding the health status of the patient as well as a library of questions corresponding to diseases and symptoms so that the evaluation engine 56 can generate further questions, diagnoses or treatments. The rule base 174, 184, 194 checks the data provided by the patient 20 against the reference data provided by the knowledge base 170, 180, 190 to determine conditional relationships between data points that would suggest a question, a diagnosis, or a treatment. Finally, the inference engine 178 188, 198 implements the conditional rules of the rule base 174, 184, 194 and the knowledge stored in the knowledge base 170, 180, 190 to generate additional questions, diagnoses, or treatments.

The inference engine 178 of the IDD module 52 checks the conditions within the rule base 174 based on the information within the knowledge base 170 to determine the scope of further questions. For example, within the rule base 174, there may be a condition that states, “if patient has normal fluid intake and has diarrhea, check for psychogenic problems and other illnesses.” The inference engine 178 sorts the relevant information gathered from the patient 20 that indicates the current problem is constipation. The inference engine 178 then searches and reviews the medical history through the knowledge base 170 and finds that the patient has normal fluid intake by examining the patient's fluid intake compared to the normal population. The inference engine 178 thus begins to search the knowledge base 170 for questions concerning psychogenic problems and other illnesses and may find the questions, “Is there more stress than usual in your life right now?” and “Have you recently been, or are you currently, sick?”

The DxNA module 54 interprets the data collected from the IDD module 52 to make a differential diagnosis of the patient 20. The inference engine 188 sorts answers that are similar to symptoms of a single diagnosis. The inference engine 188 retrieves the answers to the questions stored in the medical history database 48 through the knowledge base 180. By using the structured entries within the knowledge base 180 and comparing these structured entries to the reported symptoms using the rule base, the inference engine 188 can then determine if these answers suggest candidate diagnoses.

DxNA module 54 includes a list of diseases, which may be represented by their unique, numerically-coded profiles of characteristic symptoms. For example, a simplified version of the code for diabetes might be a numerical representation of the phrase, “history of diabetes, thirst, frequent urination, high blood sugar.” The code assigned to each disease entity thus may contain the information necessary for the inference engine to generate diagnostic hypotheses, and to determine what information is missing with respect to these candidate diagnoses.

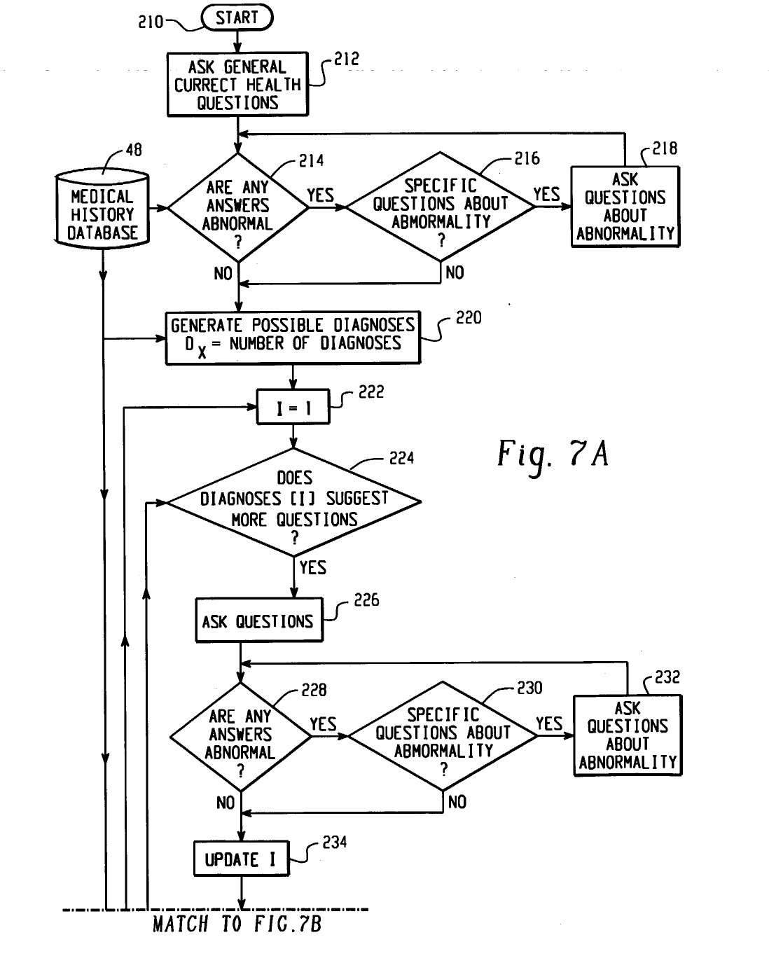

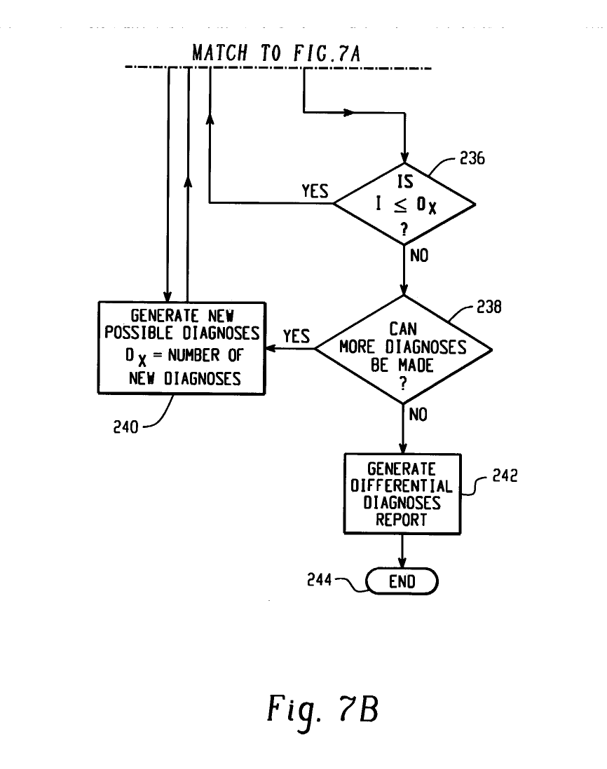

For example, three different diagnoses for diarrhea exist; enteritis, psychogenic diarrhea, and ulcerative colitis. Each of these diagnoses has a set of pertinent symptoms found within the patient that include symptoms of diarrhea. Enteritis is generally caused by an infection in the intestinal tract by a virus or a bacteria, such as cholera. Psychogenic diarrhea is associated with nervous tension. Ulcerative colitis is a disease where the walls of the large intestine are inflamed. Little is known of ulcerative colitis except that it is generally heriditary, and family members may have had an ileostomy. Therefore, the rule base 184 of the DxNA module 54 may contain rules such as, “if patient has diarrhea and is stressed, then psychogenic diarrhea is a possible diagnosis,” “if patient has diarrhea and has recently had an infection, then enteritis is a possible diagnosis,” and finally, “if patient has diarrhea and family member has/had an ileostomy, then ulcerative colitis is a possible diagnosis.” The inference engine 188 reviews the medical history through the knowledge base to determine if these symptoms are present in the patient 20, and returns a differential diagnosis from the evaluation engine 50. If the information gathered through the knowledge base 184 is inconclusive, then additional questions are asked through the IDD module 52 as is further explained below with reference to FIGS. 7A and 7B. Once the differential diagnosis is reviewed and a diagnosis is made, the treatment module 56 then determines possible treatments.

The three components of the treatment module (the knowledge base 190, the rule base 194, and the inference engine 198) similarly interact to search chosen treatments for the selected diagnosis. For example, if the diagnosis is enteritis (diarrhea caused by virus or bacteria), the physician 30 may select from a number of diagnosis that vary in magnitude. These treatments are generated by examining the data entered by the patient. If the patient 20 exhibits no signs of dehydration, the physician 30 might simply prescribe an antibiotic and high intake of fluids rich in electrolytes, such as Gatorade. The choices of antibiotics is prescribed by the treatment module 54. If the patient 20 is allergic to a certain antibiotic, such as penicillin, then that antibiotic will not be included in the possible treatments. Also, if records show that a particular antibiotic has been ineffective for this patient, it may also be removed from the possible treatments list. If the patient 20 has begun to exhibit signs of dehydration, then the physician might chose a more invasive treatment, such as sending the patient to a hospital and receiving solutions of glucose and saline intravenously. In general, the treatment module 54 generates a range of treatments based on intensity so that the physician 30 can chose the appropriate level of treatment. The knowledge base 190 also includes instructional information that is matched to the prescriptions so that when a physician 30 chooses a treatment, he may also choose instructions to accompany the treatment. The output of the treatment module 56 is a report of possible treatments and an accompanying instruction set.

FIG. 6 is a detailed diagram of the reference database 58 shown in FIG. 1. The reference database 58 stores information that is used to interface with the evaluation engine 50, and it is also searchable through the physician interface 44. The reference database 58 includes a general medical reference 200, a graphical medical reference 202, and a general treatment reference 204. The references 200-204 include searchable database structures so that the evaluation engine 50 may search through the database structures using the structured queries of the knowledge bases 170, 180, and 190. The physician interface 44 is also configured so that a physician may generate queries for the database structures 200-204 based on his need for further information.

The general medical reference 200 includes information regarding symptoms, traumas, diseases, and other medical conditions. This information is stored such that any one of these categories can be searched. For example, a query can be generated to search for all diseases where vision is blurred. The general medical reference 200 is searched for diseases where blurry vision is a symptom. The general medical reference 200 then outputs a list of diseases. Another query may request the symptoms associated with meningitis. These queries are generated through the IDD and DxNA modules 52 and 54 or through a physician's reference within the physician interface 44.

The graphical medical reference 202 includes graphical information that can be displayed in the patient interface 42 and the physician interface 44. The graphical information contained within the graphical medical reference 202 may include photographs, illustrations, 3-D models, radiological images, animations, etc. For example, a photograph may show skin lesions for which the patient 20 must pick the closest match. Or, in order to describe a source of pain in the hand, an illustration may label parts of the hand in cutaway view so that the patient 20 can use descriptive terms that the physician 30 can then interpret. An animation may rotate the knee joint so that the patient 20 can pin point the orientation of the knee when pain occurs. The graphical medical reference 202 is thus a tool that can help a patient 20 and a physician 30 better communicate the medical condition.

The general treatment reference 204 includes information on treatments, instructions for implementing treatments, and the diseases for which the treatments are effective. The general treatment reference 204 is generally searchable by disease or by symptom, but a physician 30 may also search through prescriptions to see what similar treatments can be prescribed that have similar effects. For example, if the patient 20 is allergic to penicillin, but requires an antibiotic for a medical condition, then the treatment module 56 will query the treatment reference 204 for similar antibiotics that are listed as treatments for that medical condition. If a physician would rather not use a certain antibiotic, he may query the general treatment reference 204 for a list of similar antibiotics from the physician interface 44. The reference database 58 thus includes reference material from the population of patients that have been treated by physicians through the system 10.

Turning now to FIGS. 7A and 7B, a logical flow chart sets forth the preferred steps enabled by the server applications 46 of the present invention. The flow chart describes the process that is implemented via the IDD module 52 and the DxNA module 54 in questioning a patient and diagnosing the medical condition.

The process starts at step 210, which is after the patient 20 has generally described the current medical problem as set forth above. The system 10 then asks general health questions in step 212. The answers to these questions are checked against normal answers stored in the reference database 58 in step 214. If any of the answers are abnormal, then the knowledge base 170 of the IDD module 52 determines if specific questions about the abnormality exist in step 216. If more specific questions exist, then in step 218 the IDD module 52 asks these specific questions through the patient interface 42. If no answers are abnormal, or no more specific questions about an abnormal answer exist, then the DxNA module 54 generates a list of diagnoses and assigns the number of diagnoses to a variable DX in step 220.

A counter, I, is initialized to 1 in step 222. In step 224, the DxNA module 54 determines if the Ith diagnosis suggests that more specific questions should be asked based on the symptoms that have been reported in the Ith diagnosis and the symptoms that are traditionally associated with the diagnosis that have not been ascertained from the previous questions presented in step 212. The DxNA module 54 generates a list of the data that is required to validate or invalidate a diagnosis, and then sends that information back to the IDD module 52. If more specific questions exist, then the IDD module 52 asks these specific questions in step 226. The answers to these questions are then checked against normal answers stored in the reference database 58 in step 228. If any of the answers are abnormal, then the knowledge base 170 of the IDD module 52 determines if additional specific questions about the abnormality exist in step 230. If additional specific questions exist, then in step 232 the IDD module 52 asks these questions through the patient interface 42. Once all the questions from steps 228 and 230 have been asked and answered, the counter I is then updated in step 234.

Step 236 determines if the counter, I, is less than or equal to DX. If I is less than or equal to DX (the number of diagnoses in the differential diagnosis), then the process returns to step 224 to determine if the next diagnosis suggests that additional questions should be asked of the patient 20. If, however, I is greater than DX, then in step 238 the DxNA module 54 determines if more diagnoses can be made. If more diagnoses can be made, then step 240 generates new possible diagnoses and DX is reassigned to the new number of diagnoses. The previous diagnoses are kept for future reporting. The counter I is re-initialized to 1 at step 222 and the process of asking questions begins again at step 224. If no more diagnoses can be made at step 238, however, then the differential diagnosis report is generated at step 242 and the process ends at step 244.

FIGS. 7A and 7B generally show the recursive steps of the IDD module 52 and the DxNA module 54 of FIG. 1. These steps 212-218 include the intelligent data drilling procedures of the IDD module 52. Once the IDD module 52 has fully drilled through the questions contained within the reference database 58 and gathered through the knowledge base 170, then the DxNA module 54 generates diagnoses as shown in step 220. The candidate diagnoses are evaluated to determine if other symptoms might be present in the patient that have not been ascertained because the patient has not been questioned about those symptoms. The DxNA module 52 then passes the symptoms and diagnoses to the IDD module 52 so that the IDD module 52 can present the more specific questions to the patient as shown in steps 226-232. This process repeats until all of the relevant questions are asked that are related to any of the diagnoses from the candidate diagnosis list. The process will also repeat until internal data point conflicts are resolved to a predetermined level of congruency. Alternatively, the system 10 may only cycle a predetermined number of times, regardless of conflicts or additional questions. The flow chart of FIG. 7 thus reduces a very broad search of medical conditions to a few likely candidate diagnoses and builds a differential diagnosis as shown in FIGS. 8A and 8B

FIGS. 8A and 8B set forth a graphical depiction showing the layout of a differential diagnosis display generated by the server applications 46 and viewed through the physician interface 44. The differential diagnosis display includes a general description of the patient 260, a chart 270, a systemic scale 272, a differential diagnosis 274, a text box 276 and a submit button 278 to enter a diagnosis. The general description 260 includes pertinent data 262 from the medical history database record of the patient, a current complaint 264, and graphical displays 266. The pertinent history includes allergies, current medications, significant medical history, social history, etc. The graphical displays 266 include the pictures and/or 3D models that the patient 20 manipulated or selected when interacting with the patient interface 42. These pictures and/or 3D models could include a general body view where the patient 20 chose an affected region, a display of the affected region, and a close-up of the affected region.

From step 242 of FIG. 7B, the chart 270 of the patient's complaint is generated, and includes the affected systems, differential diagnosis and pertinent positives and negatives regarding the current complaint. The pertinent positives and negatives are based on the answers to the questions generated by the IDD module 52 as they pertain to the differential diagnosis list. The chart 270 is organized by system, such as urinary, digestive, pulmonary, integumentary, and nervous systems. A general category is included for symptoms that do not exactly fall into one of the system categories. Furthermore, any one condition can affect multiple systems. A pulmonary problem may create a sluggish feeling and also make body parts tingle because oxygen does not reach outer body parts. This type of condition can cause many systems to have symptoms that suggests a more serious condition that may require immediate medical help. The systemic scale 272 is a measure of how complicated a diagnosis is to make and helps determine if either immediate help or a doctor's visit, where lab work can be taken, is required. The systemic scale reflects how many systems are affected by the reported symptoms.

The systemic scale 272 of the differential diagnosis display measures the level of interaction of a condition on multiple systems. The systemic scale 272 measures the likelihood that a condition may be more complicated than a simple verbal exam with minimal tests can determine. While some tests may be available at the remote location of the patient 20, the patient 20 will not generally have access to tools to process blood samples, urine samples, stool samples, etc. If the condition elicits a response on the systemic scale that is above a particular threshold, then the physician 30 interviewing the patient 20 can suggest an immediate visit to a local specialist to have tests drawn.

Furthermore, a validity scale may be separately shown. The validity scale reflects the internal consistency of the data set. The validity scale may be represented by a strict pass/fail guideline or by a multilevel, continuous scale similar to the systemic scale.

The systemic scale 272 is also a measure of the likelihood that all of the relevant questions have been asked. When more systems are involved in the diagnosis, it is more difficult to ensure complete coverage of questions, and thus the systemic scale 272 can serve as a warning to the physician 30 that certain information may not have been gathered. The physician 30 may then engage the patient 20 to determine the information needed, or the physician may suggest that the patient visit a local specialist to obtain specific laboratory tests or radiological tests.

Using this interface screen, the physician can then review the suggested differential diagnosis 274. The suggested differential diagnosis 274 is a list of the possible diagnoses generated by the DxNA module 54. The differential diagnosis 274 maybe ordered based on the likelihood that a particular diagnosis is the best diagnosis given the symptoms of the current condition. The differential diagnosis display also contains suggested laboratory tests or radiological tests to order for uncomplicated cases. In these tests, the patient 20 may be able to take the data at home and mail in a sample, or may be able to go to any local clinic to have the test taken. Finally, once the physician has convinced himself of a diagnosis, the physician enters the diagnosis in the text box 276 or selects the diagnosis from the differential diagnosis list. The physician 30 then clicks the submit button 278 to begin the treatment module 56.

For example, the patient depicted in FIG. 8 is a 34 year old female. She is complaining of pain and burning when she urinates. The graphical data presented to her may have been a full body picture on which she highlighted the pelvic region. Within the affected region she may have chosen the lower pelvic region, and finally chosen the exact region of burning within the close up diagram of the affected region. The pertinent medical history includes information as to the patient's sexual behavior, current medications and any ongoing medical treatments such as for depression. It is also noted that she is allergic to penicillin so that other antibiotics should be chosen should she need that type of medication.

Her system chart shows pertinent negatives in the general, digestive, and genital tract systems. This suggests that these systems are not affected by the condition. While the urinary tract shows several pertinent negatives, these pertinent negatives more fully define what the diagnosis should be by eliminating other possible diagnosis. The pertinent positives of the chart, such as burning, urgency and frequency of urination suggest the diagnosis includes a problem within the urinary tract. The systemic scale suggests the diagnosis is uncomplicated.

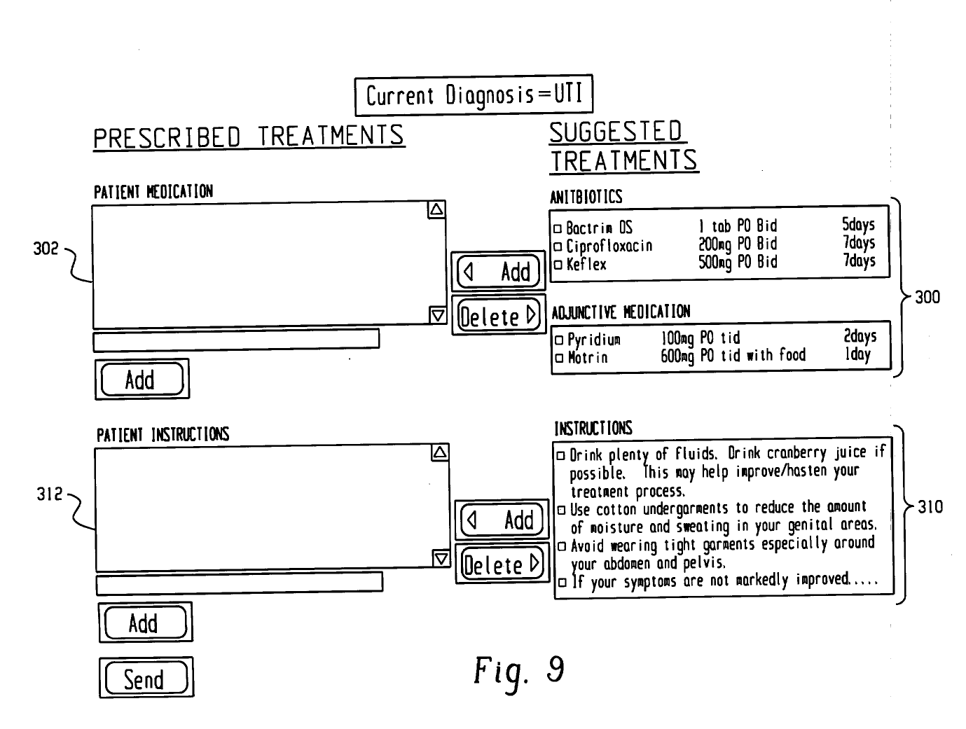

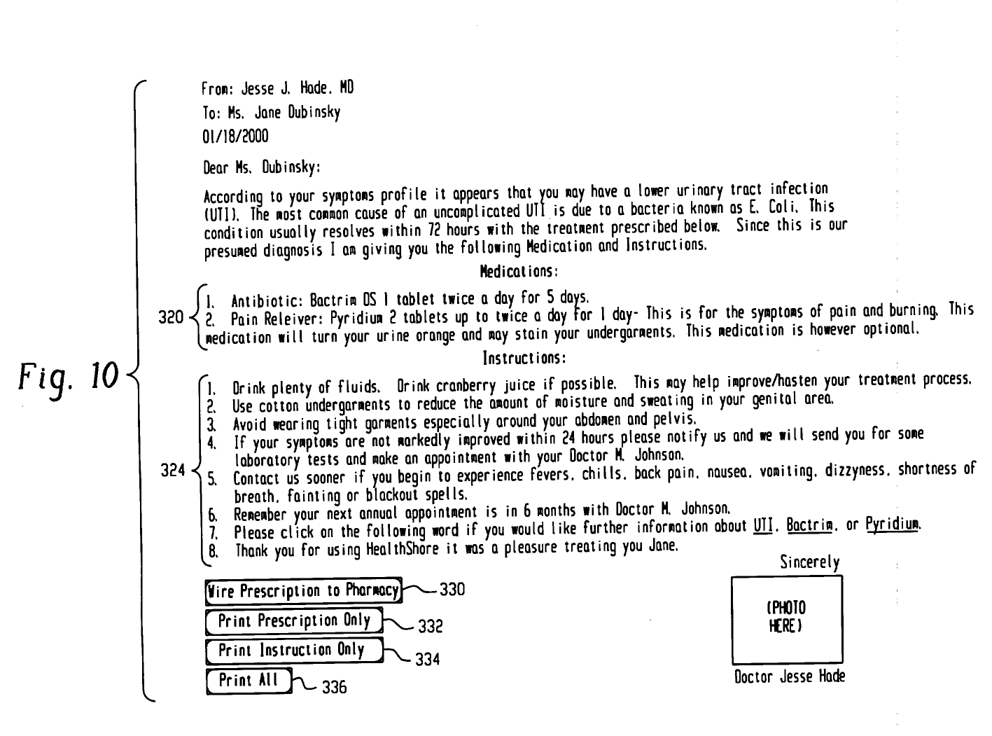

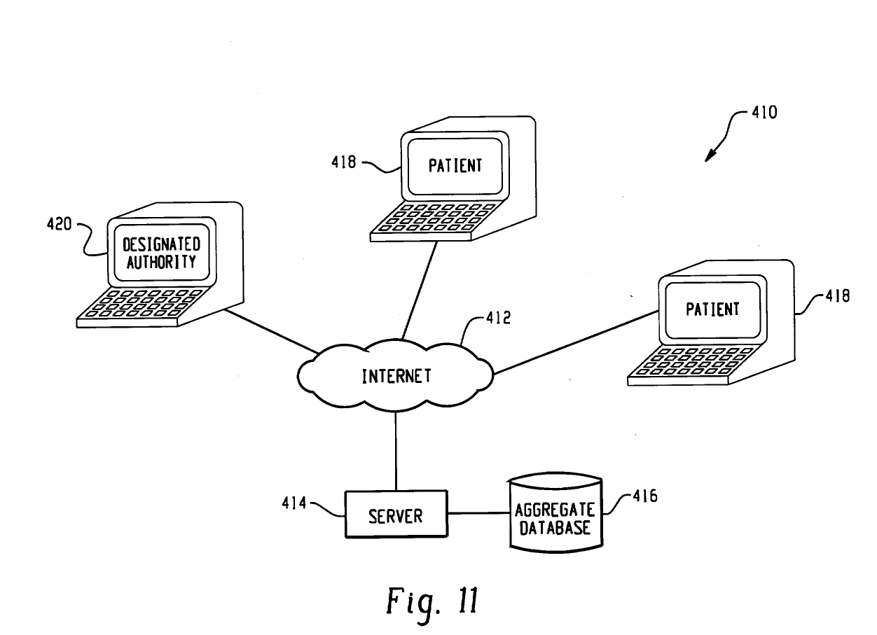

The physician 30 then reviews the suggested differential diagnosis. In order of likelihood, the diagnoses are uncomplicated cystitis-bacterial, uncomplicated cystitis-non-bacterial, and pylonephritis. The differential diagnosis display suggests a simple urine analysis test to check for the presence of a bacteria within the sample. The physician 30 can choose one of the diagnoses from the differential diagnosis or make a diagnosis outside of the differential diagnosis and enter that diagnosis on the differential diagnosis display and then proceed to generate a treatment using the treatment display of FIG. 9.

FIG. 9 is a graphical depiction showing the layout of a possible treatments display generated by the server applications 46 and viewed through the physician interface 44. The treatment display is split into two sides. The right side includes the suggested treatments 300 and suggested instructions 310 for the chosen diagnosis. The left side includes the selected treatments 300 and the selected instructions 312 from the right side of the treatment display. The physician 30 selected from the types of medication that are possible treatments 300. The physician may also prescribe an adjunctive medication which is used to treat effects such as pain or swelling or to counteract a side effect of the medication. The physician 30 may add or delete medications from the selected treatment 302 until he has found the combination of prescriptions that he believes to be the most effective. The physician 30 may also include instructions 302 for the patient 20. These instructions include how to take the medication (such as frequency, length, take with food, etc.) and other instructions for daily activities. These prescribed treatments 302 and instructions 312 are submitted to the system 10 and a physician report is generated to send to the patient 20 as shown in FIG. 10.

FIG. 10 is a graphical depiction showing an example of a physician report sent to a patient after a diagnosis and treatment regimen have been determined. The physician report includes the medications that are prescribe and the directions for the medication use 320, and a list of instructions for the patient 324. The physician report also includes secure, authorized, and verifiable links to wire the prescription to the pharmacy system 330, print the prescription 332, print the instructions 334 or print the entire report 336. Other links (that can be included in hyperlinks) allow the patient 20 to review the medical condition for a description of prescribed drugs, the disease or any other terms that are not commonly known. Once the patient 20 has received the physician report, the consultation is complete and the patient 20 may begin treating the condition.

The example shown within FIGS. 9 and 10 is the treatment display and physician report of the woman complaining of pain when urinating shown in FIG. 8. Here, the physician 30 selected the diagnosis of uncomplicated cystitis-bacterial. The physician 30 then proceeds to the treatment display of FIG. 9. The suggested treatment includes an antibiotic and pain medication. The choice of antibiotics include Bactrim DS, Ciproflaxacin, and Keflex while the adjunctive medication for pain includes Pyridium and Motrin. The physician 30 selects an antibiotic and an adjunctive medication and adds each to the left hand side of the treatment display. The physician 30 also adds a number of instructions for daily habits that should help rid the patient 20 of the infection. Once these choices are made, the physician 30 sends the physician report of FIG. 10 to the patient 20. The physician report includes the list of medications the physician chose along with the chosen instruction set. The physician report includes details that were not seen on the physician report such as side effects (i.e., the medication will turn your urine orange) and a general description of the condition. The treatment and condition are then added to the database record of the patient 20 so that the physician 30 may review this treatment the next time the patient 20 visits the site 10.

The preferred embodiments described with reference to the attached drawing figures are presented only to demonstrate certain examples of the invention. Other elements, steps, methods, and techniques that are insubstantially different from those described above and/or in the appended claims are also intended to be within the scope of the invention.

FIG. 11 shows another embodiment of the invention. This embodiment is an online medical diagnostic system 410 that is especially suited for a situation encountered after an act of terrorism. The system 410 can communicate with a patient through a browser interface from a remote location, such as over the Internet 412, to query the patient and to receive his/her responses. Based on the patient's responses, the system 410 determines the likelihood of the patient having a particular ailment. Based on that likelihood, the system 410 sends relevant instructions and information to the patient. The system 410 can also communicate with a designated authority (DA) through a browser interface from a remote location. The DA can be a doctor, designated and authorized to modify the operating parameters of the system 410. Using the browser, the DA to enter and modify operating parameters of the system 410. The operating parameters govern what questions and information the system 410 sends to the patient and how the patient's responses are processed.

The system 410 includes a host computer comprising a server 414 with access to a database 416. The server 414 is connected, preferably via the Internet 412, to patient computers 418. The patient computers 418 can be personal computers in the homes of patients. In this example, patients include anyone with computer access to the Internet 412 that logs onto the server 414 to be diagnosed by the system 410.

The server 414 is also connected, preferably via the Internet 412, to a designated authority computer 420. This can be a computer used by the DA, such as a personal computer in the DA's office.

The server 414 is programmed to determine the likelihood of the patient having a particular ailment pre-designated as “active.” Whether an ailment is “active” or not is one of the operating conditions that is preset by the DA.

Operating Parameters

As mentioned above, the operating parameters govern what questions and information the system 410 sends to the patient and how the patient's responses are processed. The operating parameters include look-up tables and numbers, and messages directed to the client. The operating parameters can be set, i.e., entered or modified, by the DA. The operating parameters are preferably described as follows:

One set of operating parameters are possible ailments. Each ailment is listed in a table, along with a designation as to whether it is active or not. An example of a portion of such a table is shown in Table 1, where “true” indicates the ailment is active and “false” indicates it is not.

TABLE 1
Possible Ailments and Corresponding Active Designations

| Possible Ailment | Active |
|---|---|
| Anthrax Respiratory | True |
| Appendicitis | False |
| Arenavirus including Lassa | False |

Other operating parameters are possible symptoms, also called findings. A separate table of possible symptoms is kept for each possible ailment. A portion of an exemplary table of symptoms values might be represented as Table 2, below. A “possible symptom” is a symptom that might prompt concern for the patient having the respective ailment and is thus presented to the patient for him/her to select which of the possible symptoms he/she has. Those symptoms that the patient selects are called “found symptoms.” The table also includes an importance value corresponding for each symptom. An importance value is a measure of how strongly the symptom indicates the existence of the active ailment. The importance value thus correlates the symptom with the active ailment. The importance values are selected from a set of discrete possible values. In this example, the possible importance values are 1, 2, 3 and 4, with 4 being a strong indication of the ailment and 1 indicating a weak indication. The table of also includes, for each symptom, a designation of whether that symptom is to be included in a medical chart (or disease profile) that may be printed out for a patient.

TABLE 2
Symptoms vs. Importance Values

| | Importance | Include |
|---|---|---|
| Possible Symptom | Value | in Medical Chart |
| Body Function/Breathing/Coarse | 2 | False |
| Body Function/Breathing/Difficult | 4 | True |
| Body Function/Breathing/Hyperpnea | 3 | False |
| Body Function/Breathing/Wheezing | 2 | True |

Another operating parameter is the choice of possible ranking values, or “rankings.” A ranking is a measure of, although not necessarily directly proportional to, the probability of the patient having the ailment based on the combination of found symptoms. In this example, the possible rankings are limited to the integers 1, 2, 3 and 4, with 1 being a strong indication of the ailment and 4 being a weak indication of the ailment.

Other operating parameters are tables of threshold importance distributions, a separate table being preset by the DA for each ailment. This is best understood with reference to a related distribution called a found importance distribution, as follows. After the patient has provided the system 410 with a set of symptoms that he is found to have, the set of found symptoms can be converted to a corresponding set of importance values using Table 2. A “found” importance distribution for this set comprises a set of numbers called counts, one count for each of the four possible rankings. The first count is the number of importance values in the set that equal one, the second number is the number of importance values in the set that equal two, and so on. An example of a found importance distribution is shown in Table 3, calculated by the system 410 for a hypothetical “patient X” with respect to a particular active ailment.

TABLE 3
Exemplary Found Importance Distribution

| | # Symptoms w/ | # Symptoms w/ | # Symptoms w/ | # Symptoms w/ |
|---|---|---|---|---|
| | Importance = 4 | Importance = 3 | Importance = 2 | Importance = 1 |
| Pa- | 3 | 4 | 2 | 2 |
| tient | | | | |
| X | | | | |

The table of threshold importance distributions is best explained by the following example shown in Table 4. The table has four distributions, one for each of the possible rankings, 1, 2, 3 and 4. According to this example, the patient must have at least two symptoms with an importance of 4, at least three symptoms with an importance of 3, and so on, to be assigned a ranking of 1 by the system 410. Similarly, the patient must have at least one symptom with an importance of 4, at least two symptoms with an importance of 3, and so on, to be assigned a ranking of 2 by the system 410. The table of threshold distributions is thus used to convert a found importance distribution for a given patient and ailment to a ranking for that patient and ailment.

TABLE 4
Table of Threshold Importance Distributions

| | Threshold # | | | |
|---|---|---|---|---|
| | Symptoms | Threshold # | Threshold # | Threshold # |
| | w/Im- | Symptoms w/ | Symptoms w/ | Symptoms w/ |
| | portance = 4 | Importance = 3 | Importance = 2 | Importance = 1 |
| Rank- | 2 | 3 | 2 | 2 |
| ing = 1 | | | | |
| Rank- | 1 | 2 | 2 | 1 |
| ing = 2 | | | | |
| Rank- | 3 | 1 | 1 | 1 |
| ing = 3 | | | | |
| Rank- | 3 | 0 | 1 | 1 |
| ing = 4 | | | | |

When comparing the found distribution to the threshold distributions, if any found count of a higher importance value exceeds the threshold count required to establish the given ranking, the excess number (or remainder) may be carried over to one or more lower importance value as applicable. For example, to establish a ranking of 1, at least 2 counts of an importance of 4 are required. However, in this example there are actually 3 counts (see Table 3) of an importance of 4. The remainder, which is 1, can be carried over to help satisfy the number of counts of importance of 3. If not needed there, it can be carried over to help satisfy the number of counts of importance of 2 or below.

Other operating parameters comprise the correlation between ranking verses suspicion index, as preset by the DA. Like the ranking value, a suspicion index is a measure of the probability of the patient having a particular ailment. However, unlike the ranking value, which is not necessarily proportional to the probability, the suspicion index is proportional to and even nominally equal to the probability of the patient having the ailment. Also, whereas the possible rankings are limited to a preset group of integers, the suspicion index can be any whole number from 0 to 100%. An example of a table of rankings verses suspicion indexes is shown in Table 5. The system 410 uses this table to convert rankings to suspicion indexes.

TABLE 5
Table of Rankings vs. Suspicion Indexes

| Ranking | Suspicion Index |
|---|---|
| 1 | 90% |
| 2 | 70% |
| 3 | 50% |
| 4 | 30% |

Other operating parameters that are preset by the DA are risk factors. Risk factors are different than the symptoms. Symptoms are conditions that are abnormal for the patient, whereas risk factors are not. Also, symptoms are conditions that are suspected of being caused by the active ailment, whereas risk factors are conditions that are suspected of causing the ailment. Risk factors that are set by the DA to be presented to the patient are herein called “possible first factors.” Of those, the ones that the patient are found to apply are herein called “found risk factors.”

In this example, the risk factors fall into four categories: zipcode, occupation, preexisting health condition and special situation. Portions of example tables of risk factors for the four categories are shown in Tables 6-9. For each risk factor, the tables include a corresponding risk index. Each risk index correlates the patient's having the particular risk factor with the patient's risk of having the active ailment. The risk indexes are normalized such that a normal risk would be 100%. In Table 6, three-digit zipcodes are used. These zipcodes comprise the first three digits of the common five-digit zipcodes and accordingly designate a larger area than do the five-digit zipcodes. In Table 8, the listed health conditions can be subcategorized into systemic conditions and anatomy-specific conditions. The special situations listed in Table 9 are to be presented to the patient in a questioning manner, such as “Have you attended the Toronto Auto Show in May 2001?” for the first entry in Table 9.

TABLE 6
Table of Possible Zipcodes and their Risk Indexes

| Zipcode | Risk Index |
|---|---|
| 901 | 150% |
| 902 | 10% |

TABLE 7
Table of Possible Occupations and their Risk Indexes

| Occupation | Risk Index |
|---|---|
| Field Sales | 110% |
| Field Service | 110% |
| Home Worker | 100% |
| Postal Worker | 300% |
| Student | 100% |

TABLE 8
Table of Possible Health Conditions and their Risk Indexes

| Health Condition | Risk Index |
|---|---|
| Hear Lung | 100% |
| Hear Kidney | 90% |
| Mobility Impairment | 110% |
| Psychiatric Condition | 150% |
| Severe Visual Impairment | 130% |
| Immunosuppressive Disease | 150% |
| Major Surgery Last 10 Days | 150% |

TABLE 9
Table of Special Situations

| Special Situation | Risk Index |
|---|---|
| Attended Toronto Auto Show in May 2001 | 110% |
| Ate a McDonalds hamburger in May 2001 | 110% |
| New physical symptoms since Jan. 9, 2001 | 100% |

Other operating parameters to be preset by the DA are risk factors for the system 410 to screen for and flag during the patient interview process. The DA assigns to each flagged risk factor questions and/or comments to send the patient if the patient selects these risk factors. For example, the DA can have the system 410 query the patient whether he has been at a specific event on a specific day if a specific zipcode is selected.

Patient Interview Process

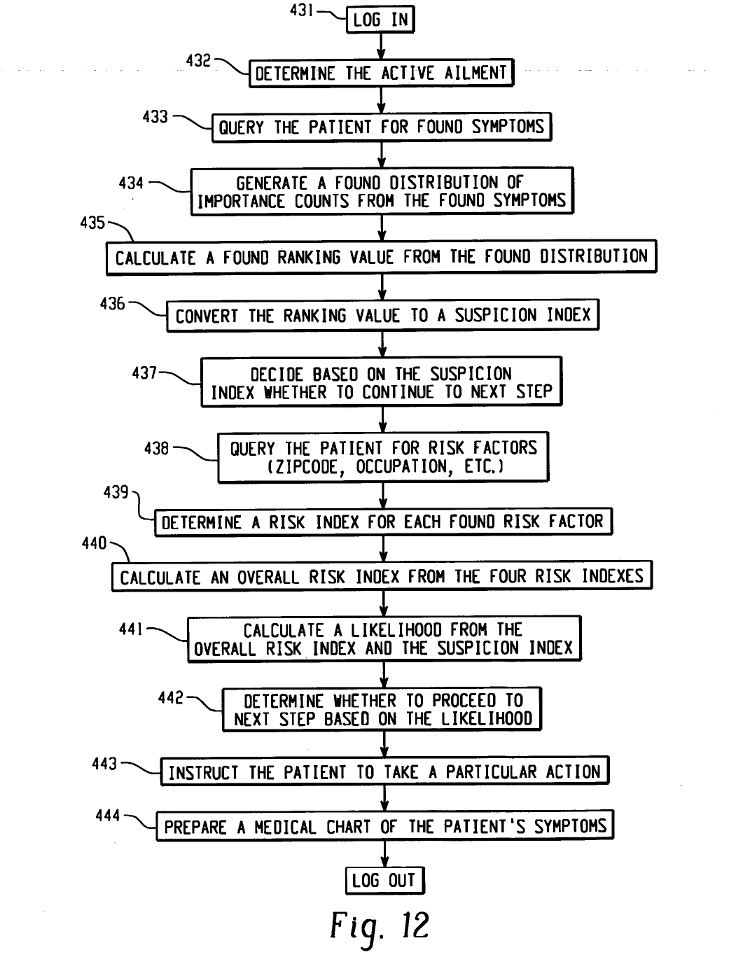

The system 410 (FIG. 11) interviews the patient according to a process that may include 15 steps 431-435 described as follows with reference to the flow chart of FIG. 12:

Step 1 designated 431) Log in: The patient logs into the system 410. This might be prompted by a person noticing that he/she has one or more abnormal symptoms. This is particularly applicable in the event of an epidemic, or of a biological, chemical or nuclear accident or attack. The person can use his home computer 418 (FIG. 11) to log into the system 410. At this point, the person is considered a “patient.”

Step 2 designated 432) Determine the active ailment: The system 410 reviews the ailment table (Table 1) to determine which ailment or ailments are currently active. In the following steps, those operating parameters relating to the active ailments or ailments are used.

Step 3 designated 433) Query the patient for found symptoms: In this step, the system 410 presents to the patient the possible symptoms from the symptom/importance look-up table (Table 2) for the active ailment. The patient responds by selecting which of the possible symptoms he has. The patient's responses are received by the server and recorded as found symptoms.

Sub-step 3a) DxNA: In a preferred implementation of step 3, during the querying procedure, the symptoms of the active diseases are checked. If a given threshold is reached, such as two or more found symptoms with finding-importance values of 3 or more, then the disease-profile-specific phase of questioning, DxNA Module 54 (FIG. 1) is triggered. This Module 54 phase was explained above with reference to the first embodiment. Each finding in a disease profile has a question associated with it. Questions related to findings for which no finding value exists are then asked. In addition, a mechanism is in place to prevent questions being asked that should not be asked because the finding related to a parent or a sibling finding would logically preclude doing so. Thus for example, if the answer to having a skin lesion of a given type is no, then the questions related to eliciting the specific features of that type of skin lesion are not asked. The patient's responses are received by the server and recorded as found symptoms.

Sub-step 3b) Review of systems: In the next phase, IDD Module 52 presents a general screening branched-chain set of questions not meant to cover every condition that a person could have but generating data relative to a nuclear, biological, chemical, or other designated category of condition. During this phase, findings related to one or more specific disease profiles are filled in. Each finding has an associated finding importance value (say on a scale of 1 to 4).

Step 4 designated 434) Generate a found distribution of importance values from the found symptoms: The system 410 converts the found symptoms to found importance values using the symptom/importance look-up table (Table 2). The system 410 then counts, for each possible importance value, the number of found symptoms having that importance value. For example, it counts how many symptoms have an importance of one, how many have an importance of two, how many have an importance of three, and how many have an importance of four. This yields a found distribution of importance counts over the four possible importance values, as exemplified by Table 3.

Step 5 designated 435) Calculate from the found distribution a found ranking for the active ailment: The system 410 compares the found distribution of importance values to the four threshold distributions in the table of threshold importance distributions (Table 4). The ranking value is determined as highest ranking value, i.e., the ranking value most highly indicating the ailment, for which each count in the found distribution meets or exceeds the corresponding count in the threshold distribution.

Step 6 step designated 436) Convert the ranking value to a suspicion index: The system 410 uses the ranking value verses suspicion index look-up table to convert the suspicion index to a ranking value for each active ailment.

Step 7 designated 437) Decide whether to continue to step 8 based on the suspicion index: The system 410 compares the suspicion index to a suspicion index threshold value. This value is one of the operating parameters that is preset by the DA. The system 410 proceeds to the following step, step 8, if the suspicion index meets or exceeds the threshold. Otherwise, the system 410 informs the patient that he/she need not take any special action.

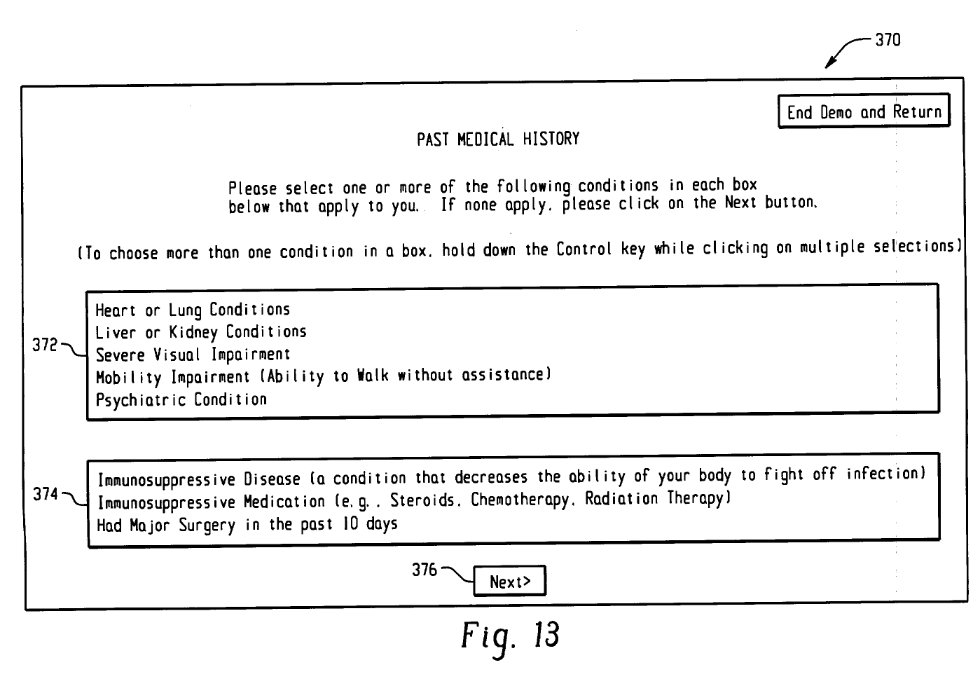

Step 8 designated 438) Query the patient for found risk factors: The system 410 presents to the patient the possible risk factors, i.e., the possible zipcodes, occupations, preexisting health conditions, and special situations for the active ailment or ailments. The system 410 queries the patient preferably using a separate computer screen window for each category of risk factor. FIG. 13 shows an example of the web page 370 that the system 410 might use to query the patient for preexisting health conditions. In this example, the anatomy-specific conditions 372 (ex: heart conditions) are listed separately from the systemic conditions 374 (ex: immunosuppressive disease). The patient is asked to select those conditions that are found to apply and then click on the “Next” icon 376. The system 410 receives and stores these found risk factors.

Step 9 designated 439) Determine a risk index for each found risk: The system 410 converts the found risk factors to risk indexes using the look-up tables (Tables 6-9) that correlate risk factors with risk indexes. This step thus yields a found zipcode risk index, a found occupation risk index, a found preexisting health condition risk index and a found special situation risk index.

Step 10 designated 440) Calculate an overall risk index as a function of the four discrete risk indexes: A preferred function for this purpose is as follows:
Overall Risk Index=(Found Zipcode Risk Index)×(Found Occupation Risk Index)×(Found Preexisting Health Condition Risk Index)×(Found Special Condition).

Step 11 designated 441) Calculate a likelihood of the patient having the ailment: The likelihood is calculated as a function of the suspicion index, the overall risk index and a multiplier. The multiplier is one of the operating conditions that are preset by the DA for each possible ailment. In this example, the function is defined by the equation:
Likelihood=Suspicion Index+[(Multiplier)×(Overall Risk Index)]
If the function yields a value greater than 100%, it is truncated to 100%.

Step 12 designated 442) Determine whether to proceed to step 13 based on the likelihood: The system 410 proceeds to the next step, step 13, only if the likelihood exceeds a threshold value. The threshold value is one of the operating parameters that is preset by the DA. If the likelihood is less than the threshold value, the system 410 sends a message to the patient that he/she need not take any special action. This can be accompanied by other preset messages, such as a thank you for using the system 410, or a disclaimer.

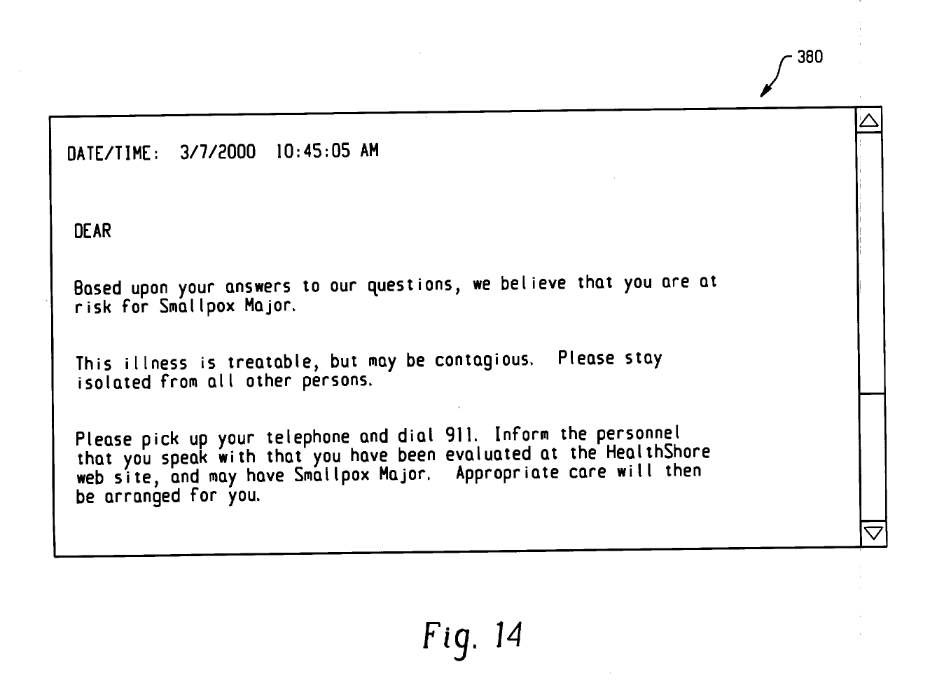

Step 13 designated 443) Instruct the patient to take a particular action: The instruction is preset by the DA. It can be, for example, to report to a particular health facility or designated care giver. The instruction can be accompanied by other preset messages, like those mentioned in step 12. An example of such an instruction and accompanying message appearing in a window 380 of a web page is shown in FIG. 14.

Step 14 designated 344) Prepare a medical chart: The medical chart, or disease profile, includes a list of the patient's found symptoms. Exemplary medical charts 480 and 490 are shown in FIGS. 15A and 15B. The chart can be printed out on the patient's computer and/or sent electronically to the designated care giver. Not all of the found symptoms are necessarily included in the medical chart. Which of the symptoms to include in the medical chart is another operating parameter that is preset by the DA.

Step 15 designated 445) Log out: This step concludes the patient interview process. The patient would then follow the system's instructions relating to seeking medical attention.

During this patient interview process, each type of query (symptoms, zipcodes, occupations, health conditions, special situations) can be performed with a separate screen. The system can screen the patient's responses for the risk factors that are preset by the DA to be flagged. When a flagged risk factor is found, the system 410 sends the corresponding question and/or comment to the patient. The question and/or comment can be sent while the patient is still on the current screen, or can be sent along with the final messages during step 12 or 13.

DA Interview Process

As mentioned above, the operating parameters are set by the DA through his computer, meaning the DA can revise these parameters, and even add and delete them where applicable. This is done through a DA interview process comprising 12 steps 401-412 described as follows with reference to the flow chart of FIG. 16:

Step 1 designated 501) Log in: The DA might be prompted to log in by a new medical incident that warrants revising the active ailment, or by new medical data becoming available that would warrant revising the other operating parameters. The login opens a home page, from which other web pages can be opened for setting respective operating parameters.

Step 2 designated 502) Set the possible ailments and corresponding active designations: The system 410 displays a table (corresponding to Table 1) of ailments and active designations. The DA can set any of these. FIG. 17 shows an exemplary web page 570 for doing this. The DA selects an ailment from list 572 of possible ailments and clicks on a “Display” icon 574. The selected ailment is displayed in a window 576. The DA checks a box 578 to designate the ailment as active, and unchecks it to designate it inactive. The change is updated by clicking an “Update” icon 579.

Step 3 designated 503) Set the possible symptoms and corresponding importance values and designations to include in the medical chart: The system 410 displays, for the ailment selected, the table entries (corresponding to Table 2) of possible symptoms, importance values and reportability designations. The DA can set any of these, meaning he can add, delete or revise possible symptoms. He can also revise their importance values and reportability designations. FIG. 18 shows an example of a web page 580 that enables the DA to revise the importance values. Importance values for each symptom are displayed in a window 582. The DA selects one of the symptoms and clicks a “Display” icon 584. The selected symptom is displayed in another window 586 and the corresponding importance appears in yet another window 588. The DA changes the importance value and clicks on a “Update” icon 589 to finalize the change.

FIG. 19 shows an example of a web page 590 that enables the DA to revise, for each symptom, the designation (reportability designation) of whether that symptom will be included in the medical chart (FIGS. 15A and 15B). Each possible symptom is displayed in windows 591 and 592 along with its reportability. The DA selects one of the symptoms, and clicks a “Display” icon 592. The selected symptom is displayed in windows 594. The DA checks or unchecks a box 596 to designate the selected symptom as reportable or not reportable. The DA can also click an “Insert” icon 597 or a “Delete” 598 icon to add or delete a symptom. Clicking an “Update” icon 599 finalizes the change.

Step 4 designated 504) Set the table of threshold distributions for a given ailment: The system 410 displays a table (corresponding to Table 4) of threshold distributions for the selected ailment. FIG. 20 shows an example of a web page 600 that enables the DA to set any value in that table for the selected ailment 608. The importance distributions are displayed in a window 602. The DA can change any importance value in the window 602 and click an “Update” icon 609 to finalize the change.

Step 5 designated 505) Set the table of ranking values and corresponding suspicion indexes: The system 410 displays the table (corresponding to Table 5) of zipcodes and risk indexes for the selected ailment. The DA can set the values in this table. FIG. 21 shows an example of a portion of a web page 610 that enables the DA to set the suspicion index for each ranking value. The possible rankings are listed in a window 612 along with corresponding suspicion indexes. The DA selects one of the rankings and clicks on a “Display” icon 614. The selected ranking is displayed in another window 616, and the corresponding suspicion index is displayed in yet another window 618. The DA changes the suspicion index and clicks an “Update” icon 619 to finalize the change.

Step 6 designated as 506) Set the possible zipcodes and corresponding risk indexes: The system 410 displays the table (corresponding to Table 6) of zipcodes and risk indexes for the selected ailment. The DA can set any of these. FIG. 22 shows an example of a portion of a web page 620 that enables the DA to set the zipcode risk indexes. The possible zipcodes are listed in a window 622 along with their corresponding risk indexes. The DA selects one of the zipcodes and clicks a “Display” icon 624. The selected zipcode appears in another window 626, and the corresponding risk index appears in yet another window 626. The DA changes the risk index and clicks an “Update” icon 627 to finalize the change. The DA can also set a message 628 and/or question 629 to be sent to the patient if a flagged zipcode is selected by the patient. The DA can also set a risk index associated with that question.

Step 7 designated as 507) Set the possible occupations and corresponding risk indexes: The system 410 displays the table of occupations and risk indexes for the selected ailment (corresponding to Table 7), and enables the DA to set them. FIG. 23 shows an example of a portion of a web page 630 that enables the DA to set the occupation risk indexes. The possible occupations are listed in a window 632 along with their corresponding risk indexes. The DA selects one of the occupations and clicks a “Display” icon 634. The selected occupation appears in another window 636, and the corresponding risk index appears in yet another window 638. The DA changes the risk index and clicks an “Update” icon 639 to finalize the change.

Step 8 designated as 508) Set the possible preexisting health conditions and corresponding risk indexes: The system 410 displays the table of health conditions and risk indexes for the selected ailment (corresponding to Table 8), and enables the DA can set them. FIG. 24 shows an example of a portion of a web page 640 that enables the DA to set the health condition risk indexes. The possible anatomy-specific health conditions are listed in a window 642 along with their corresponding risk indexes. The DA selects one of the anatomy-specific health conditions and clicks a “Display” icon 644. The selected anatomy-specific health condition appears in another window 646, and the corresponding risk index appears in yet another window 648. The DA changes the risk index and clicks an “Update” icon 649 to finalize the change. Similarly, the possible systemic health conditions are listed in a window 652 along with their corresponding risk indexes. The DA selects one of the systemic health conditions and clicks a “Display” icon 654. The selected systemic health condition appears in another window 656, and the corresponding risk index appears in yet another window 658. The DA changes the risk index and clicks an “Update” icon 659 to finalize the change.

Step 9 designated as 509) Set the possible special conditions and corresponding risk indexes: The system 410 displays the table of special conditions and risk indexes for the selected ailment (corresponding to Table 9), and enables the DA to set them. FIG. 25 shows an example of a portion of a web page 660 that enables the DA to set the special condition risk indexes. The possible special condition are listed in a window 662. The DA selects one of the special conditions and its corresponding risk index appears in another window 664. The DA changes the special condition and/or the corresponding the risk index, and clicks an “Update” icon 666 to finalize the change.

Step 10 designated as 510) Set other miscellaneous operating parameters: These other parameters include the suspicion index threshold, the risk index multiplier, and the multiplier. In this example, the multiplier can be set in a window 667 of the web page 660 of FIG. 25. The system 410 displays these parameters to the DA for the selected ailment and enables him to revise them.

Step 11 designated as 511) Set opening and closing messages: The system 410 displays the current messages, and enables the DA to set them, meaning to add, delete or revise them. The web page 660 of FIG. 25 enables the DA to do this in windows 668 and 669.

Step 12 designated as 512) Log out: This concludes the DA interview process.

The embodiment described above first queries the patient for symptoms from which to calculate a suspicion index. The risk indexes and the ailment likelihood are then determined only if the suspicion index exceeds a threshold value.

In contrast, in a yet another embodiment, at least some of the risk factors are queried before the symptoms. In this embodiment, no suspicion index is calculated, and the found symptoms do not determine whether further queries are warranted. Each finding in this embodiment has an associated finding importance value (say on a scale of 1 to 4). At the end of the first phase, target disease profiles have their findings checked and if a given threshold is reached (say two or more findings are present with finding-importance values of 3 or more), then the second phase of questioning, DxNA Module 54 is triggered. Each finding is a disease profile has a question associated with it. Questions related to findings for which no finding value exists are then asked. In addition, a mechanism is in place to prevent questions being asked that should not be asked because the finding related to a parent or a sibling finding would logically preclude doing so. Thus for example, if the answer to having a skin lesion of a given type is no, then the questions related to eliciting the specific features of that type of skin lesion are not asked.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have elements that do not differ from the literal language of the claims, or if they include equivalent structural elements with insubstantial differences from the literal language of the claims.

1. A medical diagnostic system comprising:
a server configured to present to a patient through a browser interface at a remote location a list of symptoms and risk factors and to retrieve through said interface found symptoms and found risk factors that the patient has selected from said list;
the server being further configured to calculate from said found symptoms and said found risk factors a likelihood that the patient has said ailment; and
the server being further configured to enable a designated authority to set, through a browser interface at a remote location, which symptoms and risk factors the server will present to the patient and to set parameters that the server will use in calculating said likelihood that the patient has the ailment.

2. The system of claim 1, wherein said parameters include, for each of said presented symptoms, an importance value that correlates said symptom with said ailment and that is selected from a set of discrete possible importance values, and wherein said calculating includes generating a found distribution of the number of found symptoms having each possible importance value.

3. The system of claim 2, wherein said calculating further includes determining a suspicion index as a function of said found distribution.

4. The system of claim 3, wherein said suspicion index is determined by comparing said found distribution to a set of threshold distributions to determine for which of said threshold distributions each count in said found distribution meets or exceeds the corresponding count in the threshold distribution.

5. The system of claim 1, wherein said parameters include, for each of said presented risk factors, a risk index that correlates that risk factor with said ailment, and wherein said calculating includes determining said likelihood as a function of the risk indexes of said found risk factors.

6. The system of claim 1, wherein said risk factors include zipcodes, occupations and preexisting medical conditions.

7. The system of claim 1, configured to present said risk factors to the patient only if and only after said found symptoms are received by the server and are found to indicate more than a threshold level of suspicion of the patient having said ailment.

8. The system of claim 1, further configured to instruct the patient to perform a specific action based on the level of said likelihood.

9. A process comprising:
compiling a list of symptoms related to an ailment;
compiling a list of discrete possible importance values;
assigning, to each of said symptoms, one of said possible importance values that correlates said symptom to said ailment;
presenting said list of symptoms to a patient;
receiving from the patient found symptoms that the patient has selected from said list;
generating a distribution of the number of found symptoms having each possible importance value; and
determining a suspicion index as a function of said distribution.

10. The process of claim 9, wherein the determining step includes comparing said distribution to a set of threshold distributions.

11. The process of claim 9, wherein the presenting steps and the receiving step are performed by a web server communicating with the patient through a browser interface over the Internet.

12. The process of claim 9, wherein the compiling steps and the assigning step are performed by a web server communicating with a designated authority through a browser interface.

13. The process of claim 9, further including the steps of compiling a list of risk factors related to an ailment, presenting said list of risk factors to the patient, receiving from the patient found risk factors that the patient has selected from said list, and determining a likelihood of the patient having said ailment as a function of said suspicion index and said found risk factors.

14. The process of claim 13, wherein said risk factors include zipcodes, occupations and preexisting medical conditions.

15. A process comprising:
presenting a list of symptoms to a patient that are related to a specific ailment;
receiving from the patient found symptoms that the patient has selected from said list;
calculating a suspicion index for said ailment from said found symptoms;
presenting a list of risk factors to the patient that are related to said ailment;
receiving from the patient found risk factors that the patient has selected from said list; and
calculating an overall risk index for said ailment from said found risk factors;
said second presenting step being performed only if and only after determining that said suspicion index meets or exceeds a threshold value.

16. The process of claim 15, wherein said risk factors include zipcodes, occupations and preexisting medical conditions.

17. The process of claim 15, wherein said presenting and receiving steps are performed by a server through a browser interface remote from the server.

18. The process of claim 15, further comprising calculating a likelihood of said ailment as a function of said suspicion index and said overall risk index;

19. The process of claim 18, further comprising instructing the patient to perform a specific action based on the level of said likelihood.
